(19) United States
(12) Patent Application Publication
(10) Pub. No.: US 2018/0317015 A1
(43) Pub. Date: Nov. 1, 2018

(54) SPEAKER DRIVER WITH ALIGNED FEATURES

(71) Applicant: Kimon Bellas, Camarillo, CA (US)

(72) Inventors: Kimon Bellas, Camarillo, CA (US); Alan Dwight Hulsebus, II, Simi Valley, CA (US)

(73) Assignee: Kimon Bellas, Camarillo, CA (US)

(21) Appl. No.: 15/498,311

(22) Filed: Apr. 26, 2017

(51) Int. Cl. H04R 9/06; H04R 1/10; H04R 7/12; H04R 9/02

(52) U.S. Cl. CPC H04R 9/06; H04R 1/1008; H04R 2460/11; H04R 7/127; H04R 9/025; H04R 1/1075

(57) ABSTRACT

Devices and methods described herein can comprise novel and improved designs and layouts to optimize the efficiency in speaker drivers. Embodiments of the present disclosure can include a speaker driver comprising novel and improved slot and/or gap designs. Some embodiments according to the present disclosure can optimize the efficiency of the speaker driver through the alignment of slots and/or gaps. By doing so, the air flow throughout the speaker driver can be optimized. Slots and/or gaps can be present in magnets, base cups, and/or any other component in the motor assembly of the speaker driver. Utilizing the novel and improved designs and layouts described herein, speaker drivers according to the present disclosure can have a wide array of advantages, including but not limited to the reduction of inductance buildup, reduction of inductance modulation, the reduction of air pressure, and/or the promotion of increased air flow and reduced operating temperatures.

### BACKGROUND

### Field

The present disclosure relates generally to audio transducers and/or speaker drivers, and more particularly to novel and improved speaker drivers having aligned features and improved air flow.

### Description of the Related Art

Speaker drivers are a type of audio transducer that convert electrical audio signals to sound waves. Speaker drivers are commonly associated with specialized transducers, which can reproduce a portion of the audible frequency range. Additionally, speaker drivers are sometimes referred to as loudspeakers.

A common type of speaker driver, often referred to as a dynamic or electrodynamic driver, converts electric current to sound waves via a coil of wire. This is widely known as a voice coil, which is often suspended between magnetic poles. During operation, a signal is delivered to the voice coil by means of electrical wires. This current flowing in the voice coil creates a magnetic field that causes a component, such as a diaphragm, to be forced in one direction or another. This force can move against a field established by magnetic gaps as the electrical signal varies. This back-and-forth, oscillatory motion drives the air in the device, which results in pressure differentials that convert to sound waves. Put more succinctly, speaker drivers utilize electrical audio signals to drive air through controlled movement, which in turn results in sound output. To generate a wide range of sound, different speaker drivers can be utilized to each cover a portion of the range of desired frequencies.

Speaker drivers often use a diaphragm or cone that supports a voice coil, which can in turn be on a magnet. In some speaker drivers, the voice coil resides in a position within the magnetic gap, which helps with the aforementioned oscillatory motion. The magnets in these drivers can surround the voice coil, which transforms the electrical input into the reciprocating motion. By doing so, the voice coil and magnet can form a type of motor working for and against the oscillatory motion. Some speaker drivers work only to harness these forces, and are not concerned with the exact position of driver elements.

There are several problems that traditional speaker drivers can encounter, as a result of the aforementioned oscillatory motion. For instance, this back-and-force motion causes the speaker driver components to increase in temperature. Yet within the speaker driver there is little room for cooling components or other options to reduce the temperature. The resulting heat increase can cause a variety of component problems, such as voice coil resistance increase that reduces sensitivity and causes compression. Excessive heat will cause component failure.

Additionally, some of the air caused by the aforementioned oscillatory motion can become trapped within the speaker driver. This can cause a variety of unwanted side effects, such as resonance and/or noise. Moreover, inductance buildup and inductance modulation is another problem that frequently arises in speaker drivers. Among other side effects, inductance modulation can cause distortion and reduced efficiency in the driver.

Another common problem in speaker drivers is the existence of eddy currents, which are a localized electric currents induced by a varying magnetic field. Maintaining a constant magnetic field is important to reducing the presence of eddy currents. Furthermore, speaker drivers can also experience intermodulation distortion, which is amplitude modulation of signals containing different frequencies, often caused by nonlinearities. Each of these issues present efficiency problems for speaker drivers.

### SUMMARY

The present disclosure relates to novel and improved speaker drivers that optimize component efficiency. Speaker drivers according to the present disclosure have an improved ability to reduce inductance buildup and inductance modulation. The present disclosure also provides speaker drivers that can reduce air pressure throughout the device. Moreover, speaker drivers described herein can provide a novel and improved manner in which to promote air flow to reduce the operation temperature of all components.

Embodiments according to the present disclosure can optimize the air flow within the speaker driver through the alignment of slots and/or gaps. These slots and/or gaps can be present in one or more components of the speaker driver, including but not limited to the base cup, magnet, and/or any other component in the motor assembly of the speaker driver. However, it is understood that any component in the speaker driver can utilize the novel and improved slot and/or gap design described in the embodiments herein.

One embodiment according to the present disclosure includes a speaker driver comprising a base cup including one or more slots and a magnet on the base cup, wherein the magnet can comprise one or more gaps. The one or more slots can be at least partially aligned with the one or more gaps.

Another embodiment according to the present disclosure includes a speaker driver comprising a base cup including one or more slots, an inside magnet on the base cup, and an outside magnet on the base cup adjacent the inside magnet. The inside magnet can comprise one or more inside gaps and the outside magnet can comprise one or more outside gaps. Also, the one or more slots can be at least partially aligned with the one or more inside gaps and the one or more outside gaps.

In yet another embodiment, the present disclosure can include a headphone assembly comprising a left cup assembly and a right cup assembly. Each left and right cup assembly can comprise a speaker driver, wherein the speaker driver comprises a base cup including one or more slots and a magnet on the base cup. The magnet can comprise one or more gaps, and the one or more slots can be at least partially aligned with the one or more gaps.

These and other further features and advantages of the disclosure would be apparent to those skilled in the art from the following detailed description, taken together with the accompanying drawings, in which:

### BRIEF DESCRIPTION OF THE DRAWINGS

FIG. 1A is a top side perspective view of one embodiment of a speaker driver according to the present disclosure;

FIG. 1B is a bottom side perspective view of the speaker driver in FIG. 1A;

FIG. 1C is a top view of the speaker driver in FIG. 1A;

FIG. 1D is a bottom view of the speaker driver in FIG. 1A;

FIG. 1E is a side view of the speaker driver in FIG. 1A;

FIG. 2A is an exploded perspective view of the speaker driver in FIG. 1A;

FIG. 2B is sectional cut-out view of the speaker driver in FIG. 1A;

FIG. 3A is a top side perspective view of one embodiment of a motor assembly according to the present disclosure;

FIG. 3B is a top view of the motor assembly in FIG. 3A;

FIG. 4 is a top side perspective view of one embodiment of a base cup according to the present disclosure;

FIG. 5A is a top side perspective view of one embodiment of a magnet according to the present disclosure;

FIG. 5B is a top side perspective view of one segment of the magnet shown in FIG. 5A;

FIG. 6 is a top side perspective view of one embodiment of a Faraday ring according to the present disclosure;

FIG. 7 is a top side perspective view of one embodiment of an alignment insert according to the present disclosure;

FIG. 8A is a top side perspective view of one embodiment of a negative terminal board according to the present disclosure;

FIG. 8B is a top side perspective view of one embodiment of a positive terminal board according to the present disclosure;

FIG. 9 is a top side perspective view of one embodiment of a voice coil assembly according to the present disclosure;

FIG. 10 is a side view of one embodiment of an inverted dome according to the present disclosure;

FIG. 11 is a top side perspective view of one embodiment of a front suspension according to the present disclosure;

FIG. 12 is a top side perspective view of one embodiment of a suspension ring according to the present disclosure;

FIG. 13 is a top side perspective view of one embodiment of a rear suspension according to the present disclosure;

FIG. 14 is a top side perspective view of one embodiment of a basket according to the present disclosure;

FIG. 15A is a top side perspective view of one embodiment of a grille according to the present disclosure;

FIG. 15B is a side view of the grille in FIG. 15A;

FIG. 16 is a bottom side perspective view of another embodiment of a speaker driver according to the present disclosure;

FIG. 17A is an exploded perspective view of the speaker driver in FIG. 16;

FIG. 17B is a sectional cut-out view of the speaker driver in FIG. 16;

FIG. 18 is a top side perspective view of another embodiment of a motor assembly according to the present disclosure;

FIG. 19A is a top side perspective view of one embodiment of a headphone assembly according to the present disclosure;

FIG. 19B is a side view of the headphone assembly in FIG. 19A;

FIG. 19C is a sectional cut-out view of the headphone assembly in FIG. 19A;

FIG. 20 is an exploded perspective view of one embodiment of a cup assembly according to the present disclosure;

FIG. 21A is a top inside perspective view of one embodiment of a cup according to the present disclosure;

FIG. 21B is a top outside perspective view of one embodiment of a cup according to the present disclosure;

FIG. 22 is a side view of one embodiment of a sound board according to the present disclosure;

FIG. 23 is a side view of one embodiment of a sound board cover according to the present disclosure;

FIG. 24 is a top side perspective view of one embodiment of an ear pad according to the present disclosure;

FIG. 25 is a top side perspective view of one embodiment of a tip cover according to the present disclosure;

FIG. 26 is a top side perspective view of one embodiment of a tip magnet according to the present disclosure;

FIG. 27 is a top side perspective view of one embodiment of a tip bearing according to the present disclosure;

FIG. 28 is a top side perspective view of one embodiment of a tip pole according to the present disclosure;

FIG. 29 is a top side perspective view of one embodiment of a diaphragm according to the present disclosure;

FIG. 30A is a top side perspective view of another embodiment of a motor assembly according to the present disclosure;

FIG. 30B is a top side perspective view of a magnet in the embodiment of FIG. 30A;

FIG. 30C is a top side perspective view of a base cup in the embodiment of FIG. 30A;

FIG. 30D is a top side perspective view of a top plate in the embodiment of FIG. 30A;

FIG. 31A is a top side perspective view of another embodiment of a motor assembly according to the present disclosure;

FIG. 31B is a top side perspective view of a top plate in the embodiment of FIG. 31A;

FIG. 32A is a top side perspective view of another embodiment of a motor assembly according to the present disclosure;

FIG. 32B is a top side perspective view of a base cup in the embodiment of FIG. 32A;

FIG. 32C is a top side perspective view of a top plate in the embodiment of FIG. 32A;

FIG. 33A is a top side perspective view of another embodiment of a motor assembly according to the present disclosure;

FIG. 33B is a top side perspective view of a base cup in the embodiment of FIG. 33A;

FIG. 33C is a top side perspective view of a top plate in the embodiment of FIG. 33A;

FIG. 34A is a top side perspective view of another embodiment of a motor assembly according to the present disclosure;

FIG. 34B is a top side perspective view of a bottom magnet in the embodiment of FIG. 34A;

FIG. 34C is a top side perspective view of a top magnet in the embodiment of FIG. 34A;

FIG. 35 is a top side perspective view of another embodiment of a motor assembly according to the present disclosure;

FIG. 36 is a top side perspective view of another embodiment of a motor assembly according to the present disclosure;

FIG. 37A is a top side perspective view of another embodiment of a motor assembly according to the present disclosure;

FIG. 37B is a bottom side perspective view of the motor assembly in FIG. 37A;

FIG. 38 is a top side perspective view of another embodiment of a motor assembly according to the present disclosure;

FIG. 39 is a top side perspective view of another embodiment of a motor assembly according to the present disclosure;

FIG. 40 is a top side perspective view of another embodiment of a motor assembly according to the present disclosure;

FIG. 41A is a top side perspective view of another embodiment of a motor assembly according to the present disclosure;

FIG. 41B is a bottom side perspective view of the motor assembly in FIG. 41A;

FIG. 42 is a top side perspective view of another embodiment of a motor assembly according to the present disclosure;

FIG. 43A is a top side perspective view of another embodiment of a motor assembly according to the present disclosure;

FIG. 43B is a bottom side perspective view of the motor assembly in FIG. 43A;

FIG. 44 is a top side perspective view of another embodiment of a motor assembly according to the present disclosure; and

FIG. 45 is a top side perspective view of another embodiment of a motor assembly according to the present disclosure.

### DETAILED DESCRIPTION

Devices and methods described herein can comprise novel and improved designs and layouts to optimize the efficiency in speaker drivers. Embodiments of the present disclosure can also include a speaker driver comprising novel and improved slot and/or gap designs. Some embodiments according to the present disclosure can optimize the efficiency of the speaker driver through the alignment of slots and/or gaps. By doing so, the air flow throughout the speaker driver can be optimized. Slots and/or gaps can be present in magnets, base cups, and/or any other component in the motor assembly of the speaker driver. Utilizing the novel and improved designs and layouts described herein, speaker drivers according to the present disclosure can have a wide array of advantages, including but not limited to the reduction of inductance buildup and inductance modulation, the reduction of air pressure, the reduction of component temperature and/or the promotion of increased air flow.

Speaker drivers according to the present disclosure are described herein as being utilized with headphones and/or speakers. However, it is understood that speaker drivers according to the present disclosure can be used in a wide variety of audio devices, including but not limited to headphones, microphones, hearing aids, in-ear monitors, micro speakers, tweeters, midrange speakers, woofers, and/or subwoofers. Furthermore, speaker drivers according to the present disclosure can be used in any appropriate device or transducer application, such as motors, actuators, sensors, or any similar application.

Throughout this disclosure, the preferred embodiment and examples illustrated should be considered as exemplars, rather than as limitations on the present disclosure. As used herein, the term “invention,” “device,” “apparatus,” “method,” “disclosure,” “present invention,” “present device,” “present apparatus,” “present method” or “present disclosure” refers to any one of the embodiments of the disclosure described herein, and any equivalents. Furthermore, reference to various feature(s) of the “invention,” “device,” “apparatus,” “method,” “disclosure,” “present invention,” “present device,” “present apparatus,” “present method” or “present disclosure” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. In contrast, when an element is referred to as being “directly on” or extending “directly onto” another element, there are no intervening elements present. Additionally, it is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Furthermore, relative terms such as “inner,” “outer,” “upper,” “top,” “above,” “lower,” “bottom,” “beneath,” “below,” and similar terms, may be used herein to describe a relationship of one element to another. Terms such as “higher,” “lower,” “wider,” “narrower,” and similar terms, may be used herein to describe angular relationships. It is understood that these terms are intended to encompass different orientations of the elements or system in addition to the orientation depicted in the figures.

Although the terms first, second, third, etc., may be used herein to describe various elements, components, regions, and/or sections, these elements, components, regions, and/or sections should not be limited by these terms. These terms are only used to distinguish one element, component, region, or section from another. Thus, unless expressly stated otherwise, a first element, component, region, or section discussed below could be termed a second element, component, region, or section without departing from the teachings of the present disclosure. As used herein, the term “and/or” includes any and all combinations of one or more of the associated list items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. For example, when the present specification refers to “an” assembly, it is understood that this language encompasses a single assembly or a plurality or array of assemblies. It is further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

Embodiments of the disclosure can be described herein with reference to view illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region and are not intended to limit the scope of the disclosure.

It is understood that while the present disclosure makes reference to speaker drivers with novel and efficient designs, and that speaker drivers may be the primary application concerned with the present disclosure, devices incorporating features of the present disclosure can be utilized with any application that has components or elements which might be concerned with audio devices and/or transducer applications, such as speakers, motors, actuators, sensors, or any similar application that may benefit from a novel and efficient component design.

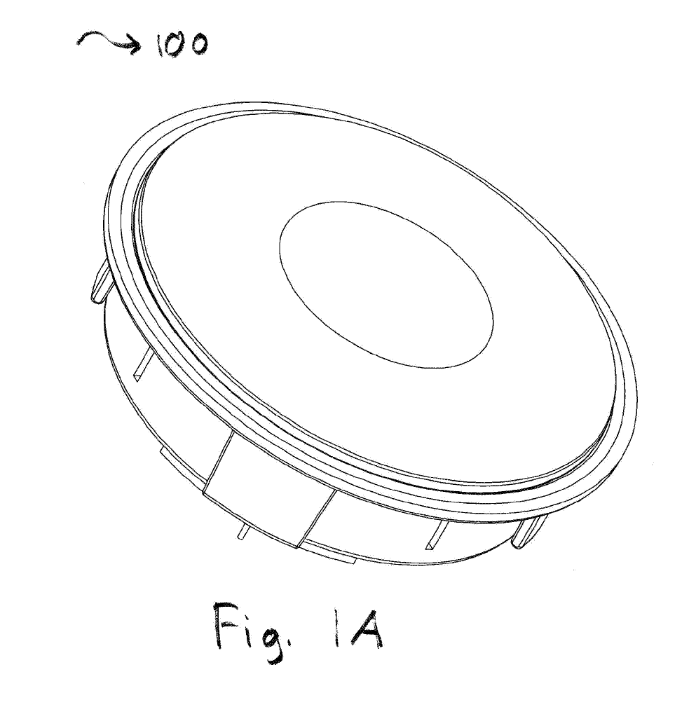

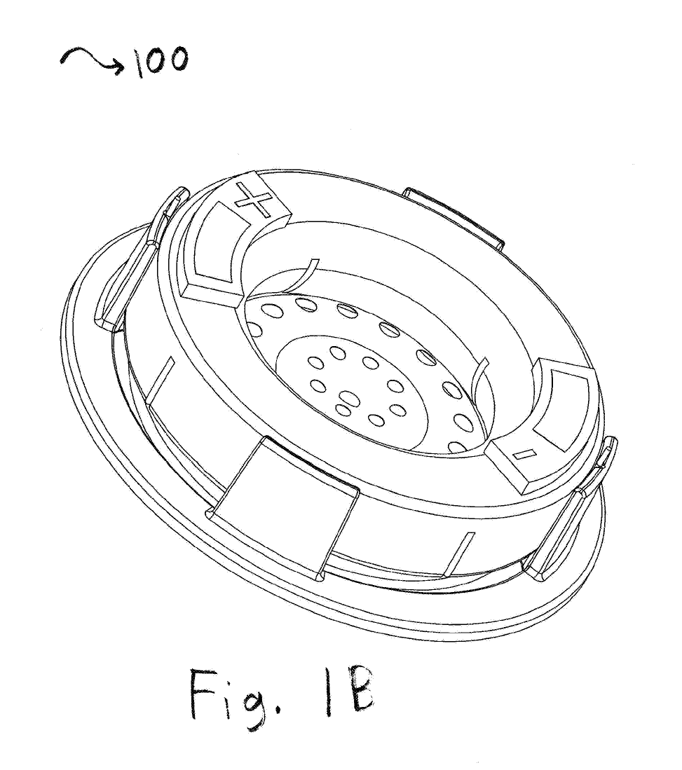

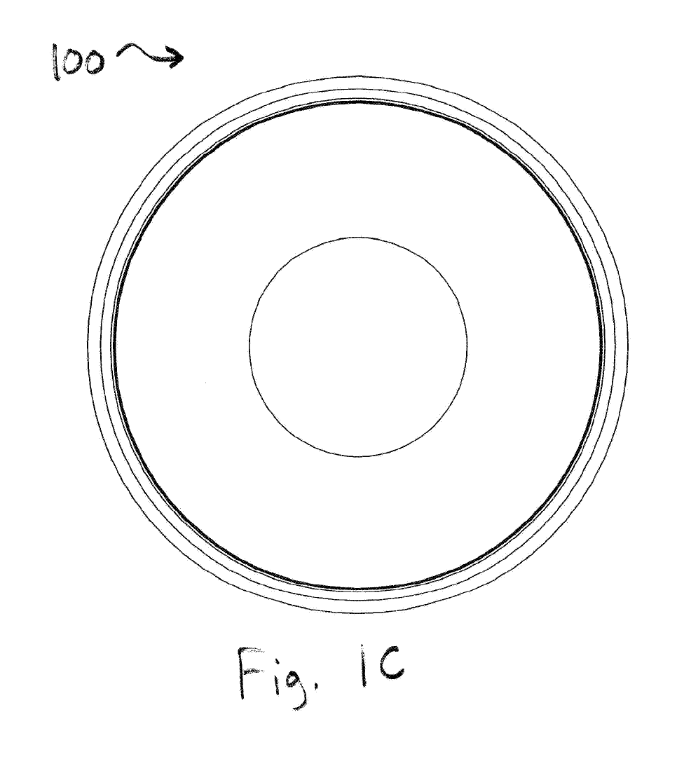

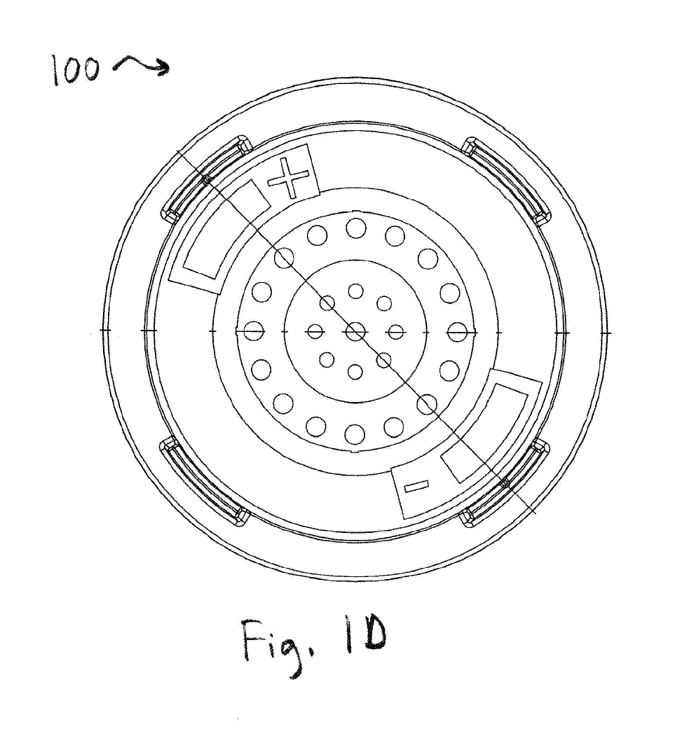

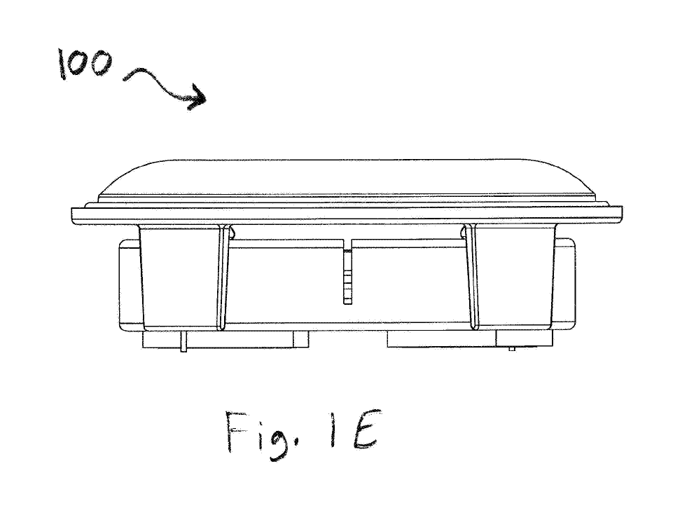

Embodiments according to the present disclosure can comprise speaker drivers with novel and improved alignment features. FIG. 1A displays one embodiment of speaker driver 100, which comprises many of the novel and improved features described herein. For instance, speaker driver 100 can reduce or limit the inductance buildup and inductance modulation in the device. Speaker driver 100 can also reduce air pressure throughout the device, as well as provide a novel and improved fashion in which to promote air flow. One manner in which speaker driver 100 can achieve these advantageous results is through the alignment of slots and/or gaps. These slots and/or gaps can be present in the motor assembly, including but not limited to the base cup and/or the magnet. It is understood that speaker driver 100 can be referred to as a speaker driver, driver, and/or audio transducer, as well as any other appropriate term.

In order to show speaker driver 100 in its entirety, FIGS. 1B-1E provide several differently angled views of speaker driver 100.

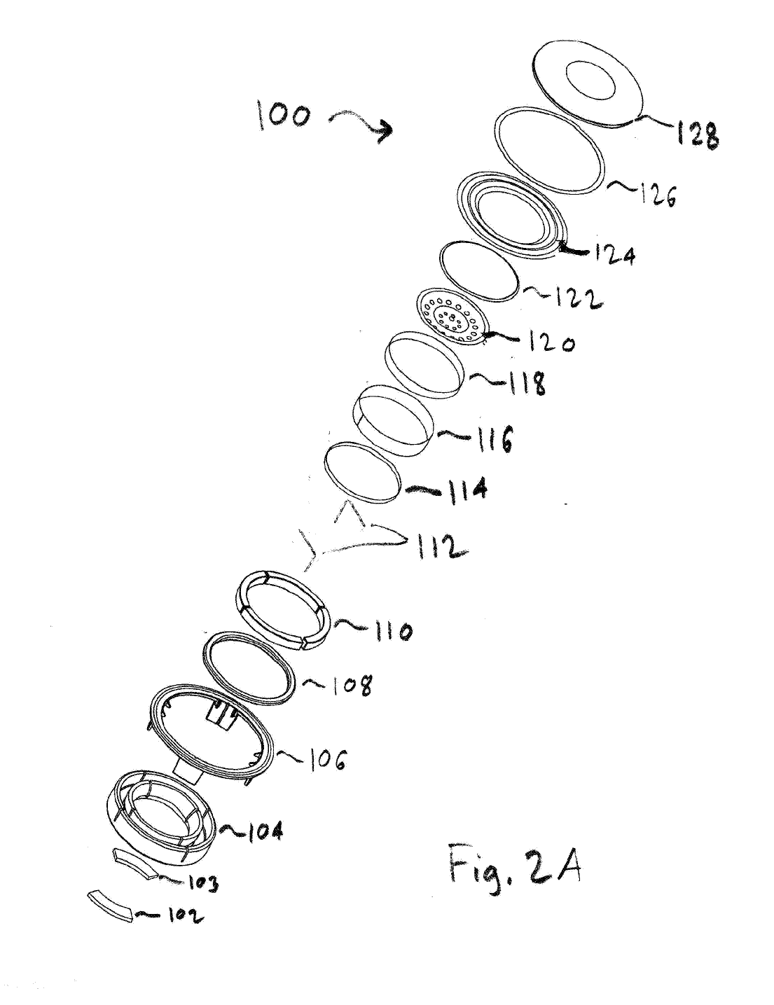

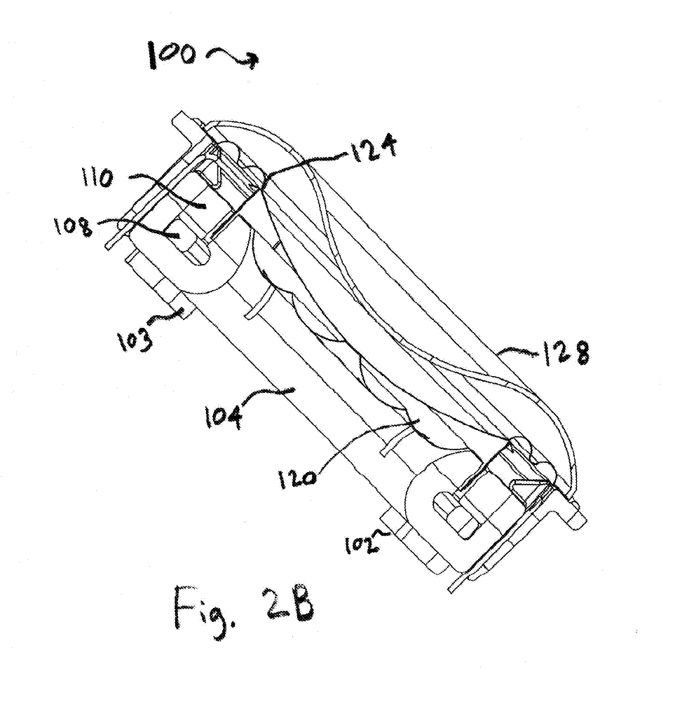

The speaker drivers according to the present disclosure comprise many different components. FIG. 2A displays that speaker driver 100 comprises base cup 104, Faraday ring 108, and magnet 110. As discussed herein, these components make up the motor assembly portion of the driver. Other speaker driver components that are adjacent the motor assembly are basket 106 and terminal board 102/103. Speaker driver 100 also comprises tensile wire 112, voice coil 114, bobbin 116, and collar 118, which comprise the voice coil assembly portion of the driver. Additionally, the top portion of speaker driver comprises rear suspension 120, inverted dome 122, front suspension 124, suspension ring 126, and grille 128.

The relative position of each component is important to the ability of the speaker driver to function property. Accordingly, FIG. 2B provides a view of the respective component positions of speaker driver 100.

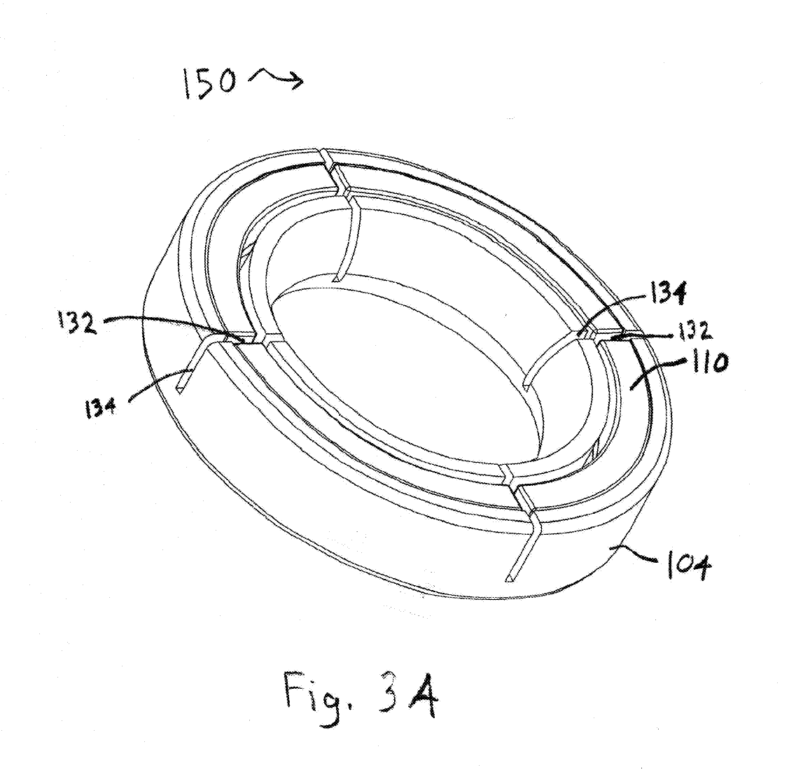

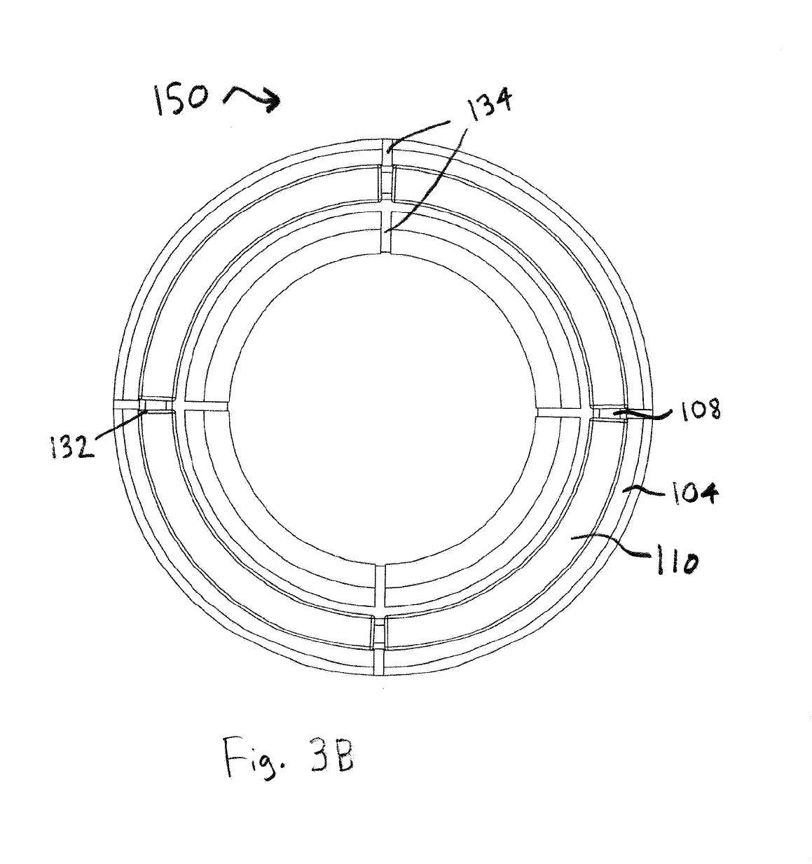

Some of the novel and improved features of the present disclosure relate to the alignment of certain speaker driver components. FIGS. 3A and 3B display motor assembly 150. Motor assembly 150 comprises base cup 104, base cup slots 134, Faraday ring 108, magnet 110, and magnet gaps 132. As displayed in FIGS. 3A and 3B, base cup 104 and magnet 110 are aligned with each other. More specifically, magnet gaps 132 and base cup slots 134 are in alignment. Although FIGS. 3A and 3B display four magnet gaps 132 and four base cup slots 134, it is understood that any number of magnet gaps or base cup slots can be used, such as six, eight, or any other appropriate number.

The alignment of magnet gaps 132 with base cup slots 134 provides many advantages to the speaker driver. For instance, the magnet gaps 132 and base cup slots 134 can reduce the amount of air that is trapped within the speaker driver. In turn, this reduces the amount of air pressure buildup in the device. This is significant because trapped air has several unwanted side effects, such as resonance and/or noise. Accordingly, aligning magnet gaps 132 with base cup slots 134 improves the overall efficiency and sound quality of the speaker driver.

Additionally, the alignment of magnet gaps 132 with base cup slots 134 allows more air to circulate throughout the driver. As improved air flow can provide cooling effects, this gap/slot alignment can also help to reduce component temperature in the device. Because the speaker driver includes many metal components that are sensitive to increases in temperature, this improved air flow can help to maintain component performance. For example, the voice coil is sensitive to temperature increases, so the increased air flow can maintain voice coil efficiency. It is understood that the improved air flow can improve the performance and efficiency of any component in the speaker driver.

Furthermore, the alignment of magnet gaps 132 with base cup slots 134 can reduce or limit inductance buildup within the device. The gap/slot alignment can increase the electrical resistance, which in turn reduces the flow of opposing “eddy” currents. Eddy currents have several negative effects on speaker drivers, such as intermodulation distortion and efficiency losses due to increases in inductance. Accordingly, the reduction of eddy currents and the reduction of inductance buildup from the aforementioned gap/slot alignment can increase the overall efficiency of the device.

The aforementioned topology of motor assembly 150 has other benefits when Ferrofluid is used in the voice coil gap. For example, the reduction of trapped air in the device can correspondingly decrease the amount of air bubbles in the Ferrofluid, which cause negative side effects like noise and/or splash. Therefore, the topology of motor assembly 150 can be especially compatible with the use of magnetized liquids, such as Ferrofluid. The motor design can also be scaled to any size speaker, such as hearing aids, in-ear monitors, other headphones, all types of microphones including dynamic microphones, micro speakers, tweeters, midrange speakers, woofers, and/or subwoofers. Motor assembly 150 can also comprise additional topologies, such as a multi-gap topology or any other appropriate topology. In one embodiment, the motor assembly can be 52 mm in diameter and weigh 51.5 grams. However, it is understood that motor assemblies according to the present disclosure can be any appropriate dimension or weight.

As displayed in FIGS. 3A and 3B, magnet gaps 132 and base cup slots 134 can have the same width. This is advantageous for a variety of reasons. For instance, if the gap/slot width is the same, this allows for a very high magnetic strength. In addition, during manufacture the gaps/slots can be formed at the same time, which significantly lowers the manufacturing cost and simplifies the manufacturing process. Furthermore, when the magnet gaps 132 and base cup slots 134 have the same width, the aforementioned air flow within the device can be fully realized.

If the magnet gaps 132 and base cup slots 134 have the same width, then embodiments according to the present disclosure can directly align the gaps/slots. This type of embodiment is shown in FIGS. 3A and 3B. However, embodiments according to the present disclosure can also comprise magnet gaps and base cup slots that are slightly offset or misaligned. Misalignment of gaps/slots can reduce the magnetic strength slightly, so it is important that the offset be limited. For example, a misalignment of +/−10% would have no significant effect on magnetic strength. Indeed, a gap/slot offset of several degrees would still allow the device to function magnetically satisfactorily. For example, an offset of this minimal variety should only result in an efficiency loss of less than 1 dB. However, as misalignment can cause the passages in the motor assembly to be slightly blocked, the advantage of improved air flow may be somewhat limited.

As displayed in FIGS. 3A and 3B, base cup 104 comprises base cup slots 134 on the inside and outside of magnet 110. As noted above, embodiments according to the present disclosure the inside base cup slots 134 do not need to directly align with the outside base cup slots 134. However, as mentioned previously, if all the gaps/slots align with one another, e.g. inside base cup slots 134, outside base cup slots 134, and magnet gaps 132, then the manufacturing cost can be reduced and the manufacturing process can be simplified. For use in larger speakers comprising two piece parts, such as woofers or subwoofers, the inside/outside base cup slots do not need to be aligned or have the same quantity.

Embodiments according to the present disclosure can also comprise magnet gaps and base cup slots with different widths, which includes its own set of advantages. Indeed, varying the width of the magnet gaps and base cup slots can help to reduce or decrease the acoustic resonance and/or noise in the device. If the gap/slot width variation is limited, it is also possible to minimally impact the magnetic strength inside the motor assembly. For instance, a gap:slot width ratio of 1:2 up to 2:1 can have a minimal impact on the magnetic strength. Accordingly, if the base cup slots are 0.8 mm wide, then the magnet gaps can be up to 1.6 mm wide. Also, if the base cup slots are 1.6 mm wide, the magnet gaps can be as low as 0.8 mm wide. These specific dimensions are used because they are standard machine shop precision saw widths. It is understood that any appropriate dimensions can be used.

It is understood that the specific measured length of the gap/slot widths are not significant; rather, it is the ratios of the gap/slot widths that are more important. The aforementioned gap/slot widths are appropriate for headphones, tweeters, micro speakers, and/or microphones. Large speakers like woofers and subwoofers can use wider gaps/slots, e.g. in the range of 1 mm to 3 mm, because the parts are larger, so the corresponding gaps/slots can be wider. If a narrower gap/slot width is desired, then laser and/or water jet cutting can be utilized. However, there is some difficulty in getting the necessary plating inside the gaps/slots for corrosion protection.

The gap/slot width can be determined by several factors, such as magnet strength, air flow volume, and/or device size limits. Wider gaps/slots can reduce the magnet mass and/or magnet strength. Moreover, if the magnet gaps and base cup slots are a different width, it can change the magnetic strength. The magnetic strength can be adjusted as necessary in order to meet the design goals of the specific device. For example, a wider gap/slot can be compensated for by increasing the magnet diameter or the magnetic intensity of the material. In one embodiment, a very high magnetic density can result in an equal slot/gap width, but it is understood that the gap/slot width needs can vary. Smaller speakers generally use smaller magnets than desired because of size limitations, so these applications can use the smallest practical slot width. In contrast, large speakers, such as woofers, are less limited by size, so the gaps/slots can be wider to maximize air flow volume.

In some embodiments of the present disclosure, the sides or face of the magnet 110 can contact the sides or face of the base cup 104. By doing so, the air gap between the magnet and the base cup is minimized in order to maximize the magnetic strength in the device. Furthermore, in order to sufficiently conduct magnetic flux, speaker drivers according to the present disclosure can attempt to maximize contact between the magnet and the base cup. The contact between these components is usually around the outer edge of the base cup. However, the contact can also be in other locations, such as the inner edge of the base cup.

As shown in FIG. 3B, Faraday ring 108 can sit in the base cup 104 below magnet 110. In this manner, Faraday ring 108 can control the height of magnet 110 within the base cup 104. More specifically, Faraday ring 108 can control the height alignment of magnet gaps 132 with base cup slots 134. Accordingly, Faraday ring 108 plays an important role in the magnetic alignment and air flow control within the speaker driver.

Magnet 110 can be directly on Faraday ring 108 in order to transfer more heat throughout the device, as well as maximize the ability to reduce inductance buildup. It is also noted that an air gap, or low permeability material like plastic, between the Faraday ring and the magnet may reduce the inductance reduction capabilities of the device. However, an appropriate material may be placed between the magnet and Faraday ring if it is necessary to balance the inductance symmetry for the forward and/or back voice coil excursion. Additionally, some embodiments of the present disclosure may not use a Faraday ring. If a Faraday ring is not used, then this area of the device can be air or a non-electrically conductive material, such as plastic or ceramic to facilitate proper component alignment.

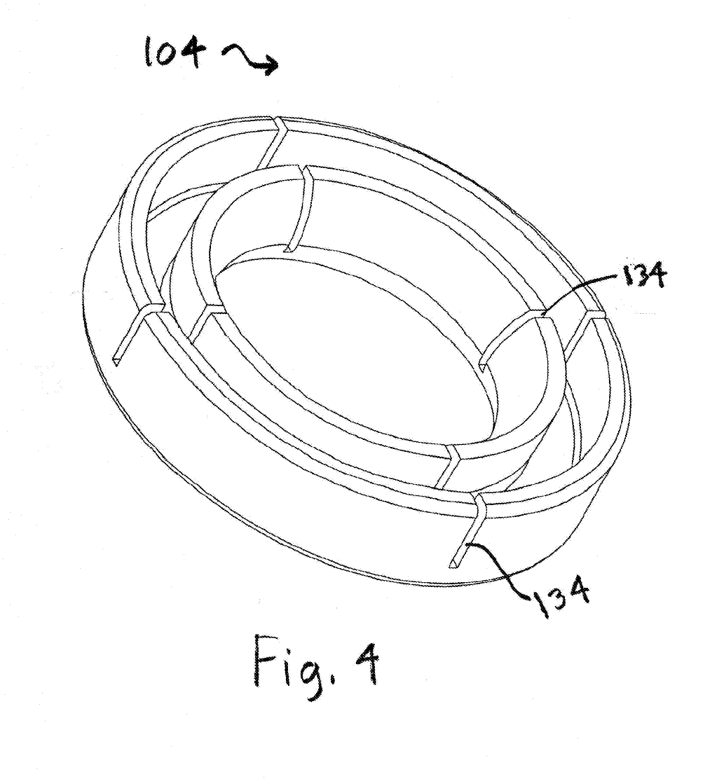

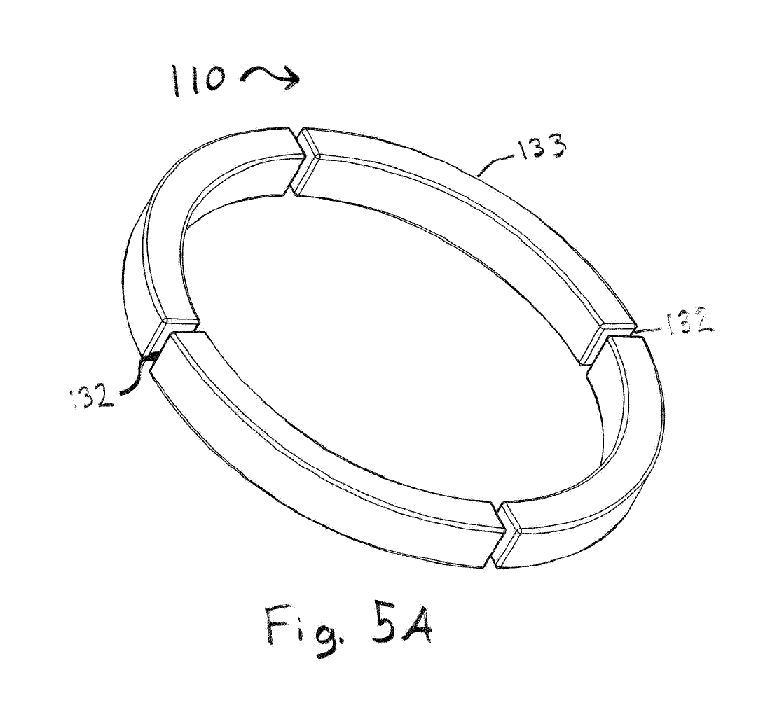

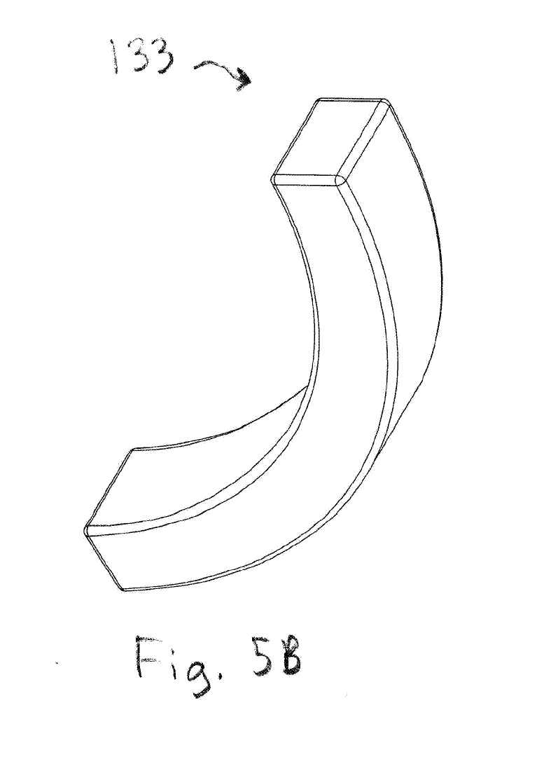

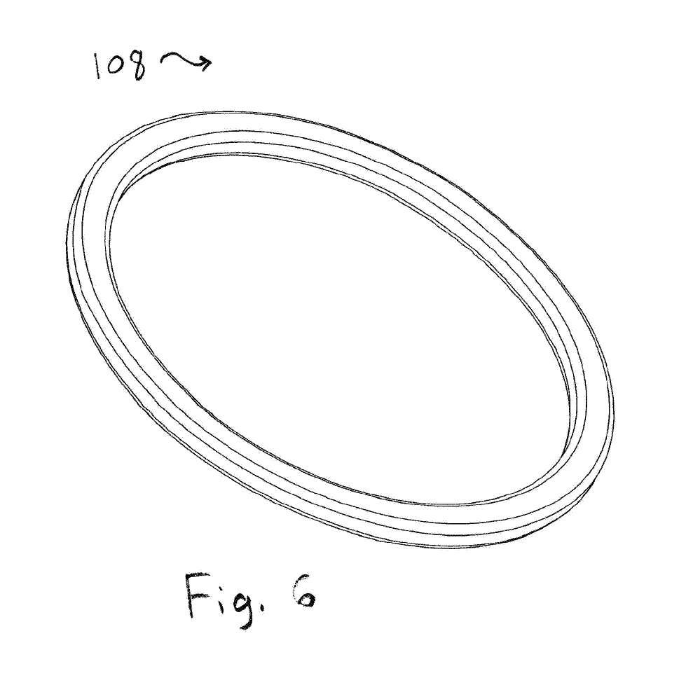

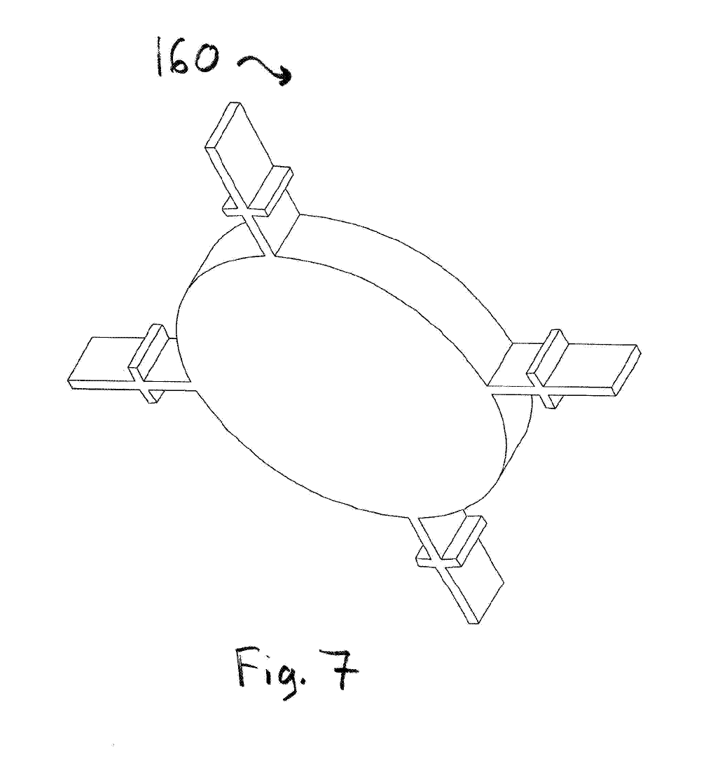

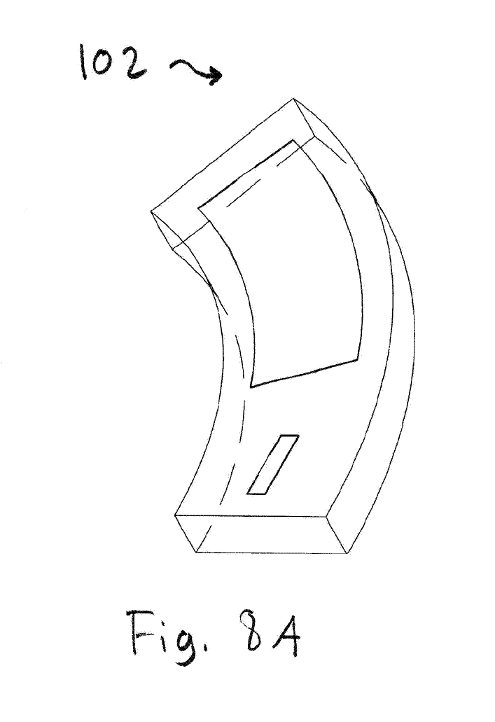

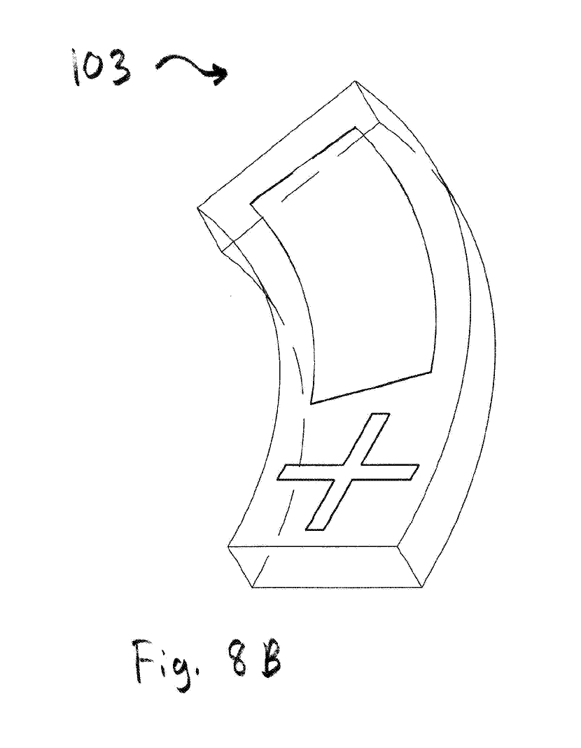

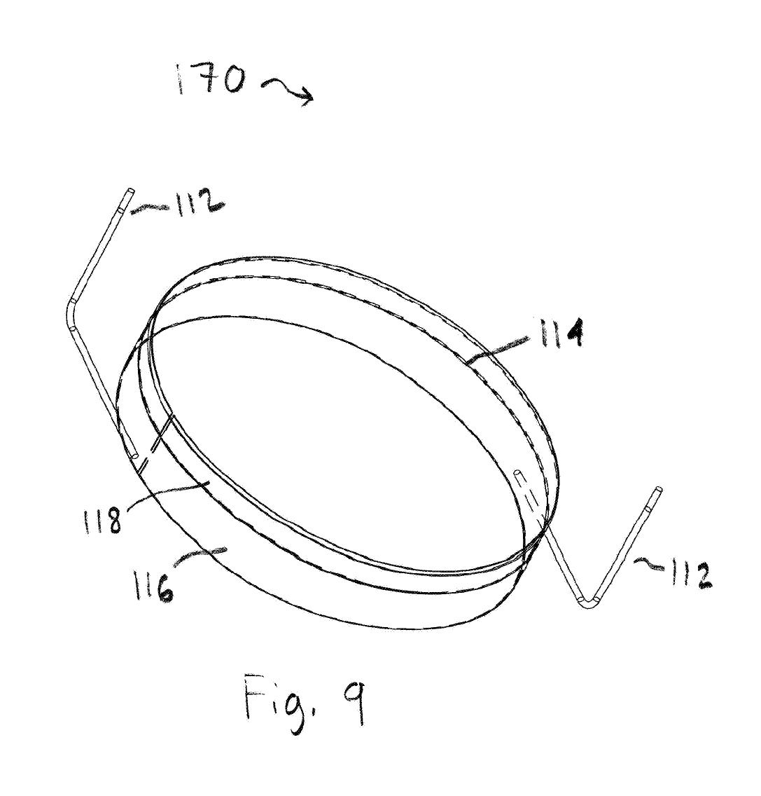

The individual components that make up motor assembly 150 are displayed in FIGS. 4-6. FIG. 4 displays base cup 104. As mentioned previously, base cup 104 comprises base cup slots 134 in both the inside and outside portions of the base cup. Accordingly, base cup slots 134 can be referred to as inside base cup slots 134 and outside base cup slots 134. As mentioned above regarding the assembly motor, inside and outside base cup slots 134 are on both sides of magnet 110, such that magnet gaps 132 are between both sets of base cup slots 134.

Base cup slots 134 can be the same thickness as magnet 110. By doing so, when the magnet is adjacent to the base cup, as in the motor assembly, the base cup slots can extend to the bottom of the magnet. Likewise, base cup slots 134 can be the same thickness as magnet gaps 132. In turn, this can maximize the air flow efficiency in the speaker driver. In some embodiments according to the present disclosure, the base cup slots can pass slightly below the bottom of the magnet. In these embodiments, the base cup slots do not extend significantly below the bottom of the magnet. However, it is understood that in other embodiments the base cup slots can be thinner or thicker than the magnet gaps. It is understood that base cup 104 can be referred to as a cup, steel cup, or magnetic gap steel, as well as any other appropriate term.

Base cup slots 134 can also reduce inductance buildup in the device by causing a high electrical resistance. For instance, given the same total air gap area, a large number of narrow slots reduces inductance more than a small number of wide slots, because the eddy current path lengths are shorter. Also, increasing the number of slots increases the perimeter surface area to transfer heat from the metal and magnet into the air, promoting better cooling. Slot perimeter surface area is superior to typical round holes, so there is better cooling. However, if the slots are too narrow, they might not be wide enough to promote air flow. As mentioned above, narrow slots are also difficult to plate to prevent corrosion.

Base cup 104 can comprise a variety of different steel materials, including steel 1010 or steel 1008. Base cup can also comprise plating, such as Rohs compliant plating. This type of plating can be 5 microns thick, and comprise zinc and gold trivalent chromate. Additionally, base cup 104 can weigh approximately 40 grams. The length of base cup can be approximately 36 mm, with a tolerance of ±0.025 mm. Further, the flatness rate of base cup can be ±0.1 mm per 25 mm, and the surface finish can be 0.002 mm. However, it is understood that base cups according to the present disclosure can comprise any number of appropriate dimensions or materials.

Embodiments according to the present disclosure can comprise several types of magnets. FIG. 5A displays magnet 110, which comprises one or more magnet gaps 132. In embodiments according to the present disclosure, magnet gaps 132 can run entirely through magnet 110. Indeed, as shown in FIG. 5A, magnet 110 can actually comprise one or more segments 133. Although four individual segments are shown in FIG. 5A, it is understood that any appropriate number of magnet gaps and individual magnet segments can be used, such as four, five, six, seven, or eight segments.

Breaking the magnet into several segments, e.g. four or more segments, allows the magnet circumference to expand and/or contract to match the base cup manufacturing tolerance, as well as equal the thermal expansion difference between the magnet and base cup. Breaking the magnet into segments can also make it easier to charge or magnetize the magnet. In some embodiments, four to eight magnet segments can be used, depending on the manufacturing requirements for the circumference and/or production constraints on magnet size. FIG. 5B displays one of the segments 133 of magnet 110. In some embodiments, the magnet gaps may not run entirely through the magnet. In these embodiments, the magnet can comprise a single large, continuous piece, rather than separate, individual magnet segments.

As displayed in FIGS. 5A and 5B, magnet 110 can be a type of magnet suitable for speaker drivers, such as a radial magnet. Furthermore, magnet 110 can be in an arc shape, such that it can be referred to as an arc magnet. Magnet 110 can also be a combination of the aforementioned magnet types, wherein it can be a radial arc magnet. More specifically, magnet 110 can be a radial magnetized neodymium arc shape magnet. It is understood that magnets according to the present disclosure can be any other appropriate type of magnet. In some embodiments, magnet 110 comprises a ceramic material. However, any appropriate type of magnet material can be used, such as Ferrite, Neodymium, Samarium Cobalt, AlNiCo, electro magnet, or any other appropriate material. Magnets can also comprise a zinc plate and weigh approximately 2.4 grams. Rare earth magnets typically have a corrosion resistant plating composed of nickel, zinc, epoxy or a combination thereof. It is understood that magnets can weigh any appropriate amount.

Other aspects of the speaker driver can reduce the buildup of inductance. FIG. 6 displays Faraday ring 108. Faraday ring 108 can have many benefits, such as reducing the buildup of, or linearizing, inductance. Reducing inductance buildup has the benefit of increasing high frequencies and reducing intermodulation distortion. Essentially, Faraday ring 108 can cause current to correctly flow through the device. Faraday ring 108 can have air flow both above and below it. It is understood that Faraday ring 108 can also be referred to as a short-circuit ring or a shorting ring, as well as any other appropriate term.

As mentioned previously, Faraday ring 108 can reduce opposing “eddy” currents that would normally flow through the device. Faraday ring 108 accomplishes this by essentially short circuiting the eddy currents. Without the Faraday ring 108, the inductance in the device can increase significantly, which can likewise increase the temperature in the device. Faraday ring 108 can comprise a number of different materials with electrically conductive properties and/or low electrical resistance. For example, Faraday ring 108 can comprise aluminum, alloy aluminum, silver, copper, alloy copper, such as brass, bronze, other copper alloys or electrical grade alloys, as well as other appropriate non-ferrous or electrically conductive materials. In one embodiment, Faraday ring 108 can weigh a few grams, e.g. approximately 1.5 grams. However, it is understood that Faraday rings according to the present disclosure can weigh any other appropriate amount.

The present disclosure also provides components which consistently and properly align the magnets with the base cup. FIG. 7 displays alignment insert 160. Alignment insert 160 can pass through the magnet gaps 132 and base cup slots 134, such that the magnet 110 is properly aligned with base cup 104. More specifically, alignment insert 160 allows magnet gaps 132 and base cup slots 134 to correctly align with one another. Accordingly, alignment insert 160 ensures that speaker driver 100 can maintain the aforementioned air flow.

Alignment insert 160 is only used during the process of assembling the speaker driver components. Indeed, alignment insert 160 is used until all components are sufficiently held in place. Once the glue or adhesive used during the assembly process has hardened, alignment insert 160 is removed from speaker driver 100. Otherwise, if left in place, alignment insert 160 would block the aforementioned air flow. It is understood that alignment insert 160 can also be referred to as an insert or a magnetic alignment insert, as well as any other appropriate term. It is also understood that alignment inserts according to the present disclosure can comprise any appropriate material, such as plastic, or more specifically Delrin plastic.

Terminal boards according to one embodiment of the present disclosure are displayed in FIGS. 8A and 8B. Specifically, FIG. 8A displays negative terminal board 102, while FIG. 8B shows positive terminal board 103. It is understood that some embodiments of the present disclosure may not use a terminal board, but rather an equivalent component, such a terminal strip or a printed circuit board, as well as any other appropriate component. In one embodiment, the terminal board comprises copper and tin material and is a black color. Specifically, the terminal board can comprise a tin plate and one ounce of copper. However, it is understood that terminal boards according to the present disclosure can comprise any appropriate material.

Embodiments of the present disclosure can also comprise novel voice coil assemblies. FIG. 9 displays voice coil assembly 170, which comprises tensile wire 112, voice coil 114, bobbin 116, and collar 118. Voice coils according to the present disclosure can be a wide variety of lengths, such as under hung, over hung, or equal hung, as well as any other appropriate length. In one embodiment, the voice coil can comprise a 32 mm diameter and a 1.75 mm thickness. The voice coil can also comprise two layers, a CCAW of 0.06 mm×42.5 turns, a 1.75 mm wind width, and a DCR of 27 ohm. Bobbin 116 can comprise Kapton, while the collar 118 can comprise Nomex. The tensile wire 112 can comprise Taiwan Maiden anti-roping, as well as be 0.5 mm×35 mm long. However, it is understood that voice coil assembly components according to the present disclosure can comprise any appropriate materials or dimensions.

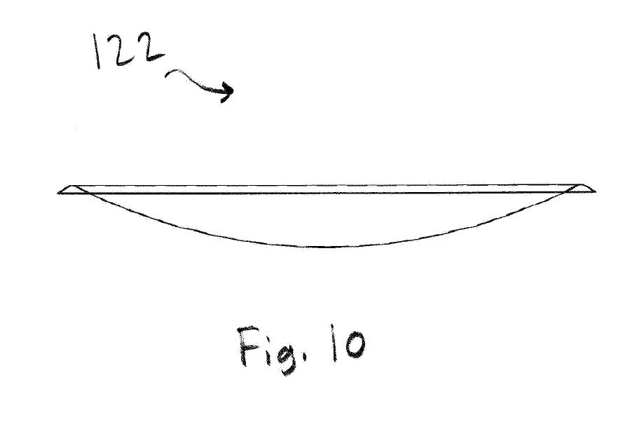

Embodiments of the present disclosure can also comprise novel dome structures. FIG. 10 displays inverted dome 122. The preferred profile of inverted dome 122 is catenary, similar to a parabola, in order to raise the break up frequency of the device. Inverted dome 122 also includes a rim fold, which facilitates with the formation of a glue pool to ease attachment with the voice coil, as well as centers the components and adds stiffness. The profile of inverted dome can also be spherical, parabolic or conical. In one embodiment, inverted dome 122 has a diameter of 34 mm, is 0.05 mm thick and is made of beryllium. The inverted dome can comprise a number of different materials commonly used to make speaker domes, such as metal foil, plastic film, plastic fibers, carbon fibers, glass fibers, cellulose fibers, ceramic, graphene or CVD diamond. It is understood that inverted domes of the present disclosure can comprise any number of appropriate materials and combination of materials.

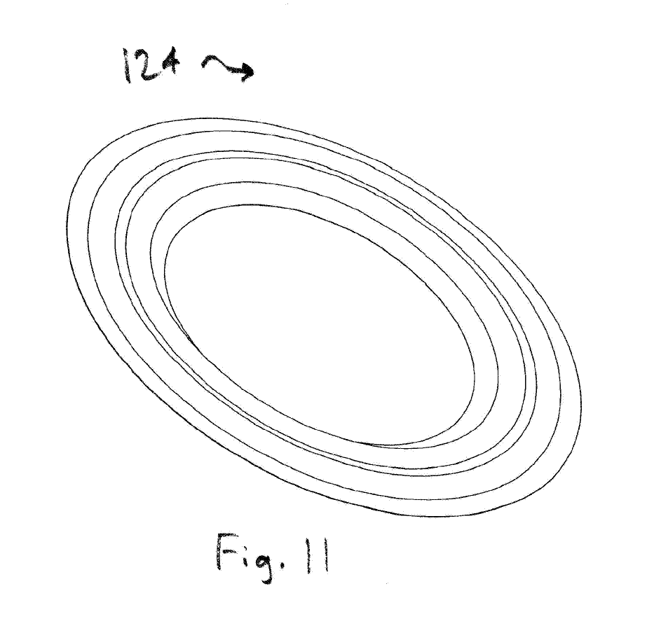

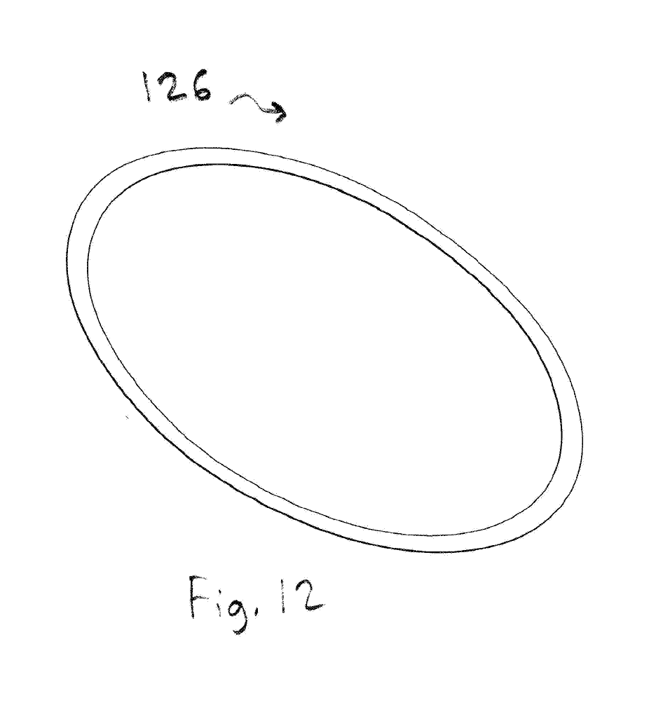

Embodiments of the present disclosure can also comprise several different components used for suspension, such as a front suspension, a suspension ring, and a back suspension. FIG. 11 displays front suspension 124 which can comprise a polyester fabric that is PVA coated, as well as comprise a suspension width of 5.5 mm. Polyester fabric that is PVA coated is commonly used to make soft tweeter domes. FIG. 12 displays suspension ring 126 that can comprise a plastic material, such as clear Polyethylene naphthalate (PEN) plastic, which can provide good reinforcement and flatness characteristics. FIG. 13 displays rear suspension 120. Like the front suspension, the rear suspension can also comprise a polyester fabric that is PVA coated, and comprise a tweeter dome fabric thickness and coating. In one embodiment, rear suspension has a diameter of 31 mm and a thickness of 2.77 mm. However, it is understood that suspension components according to the present disclosure can comprise any number of appropriate dimensions or materials.

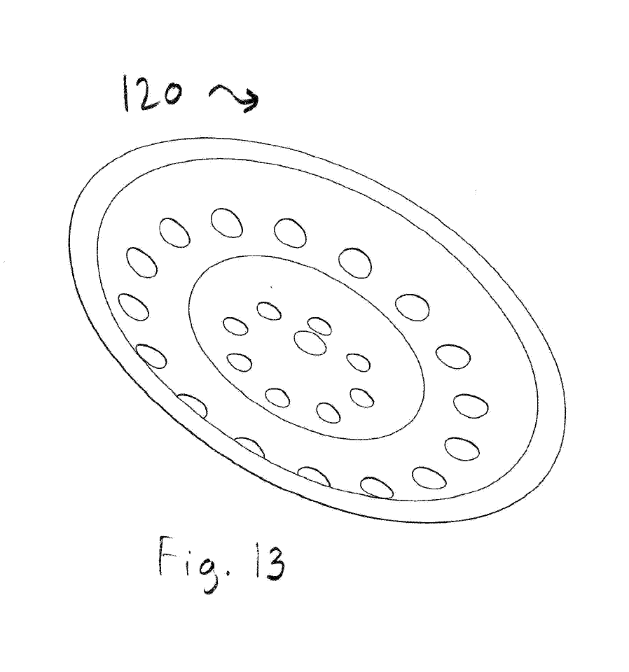

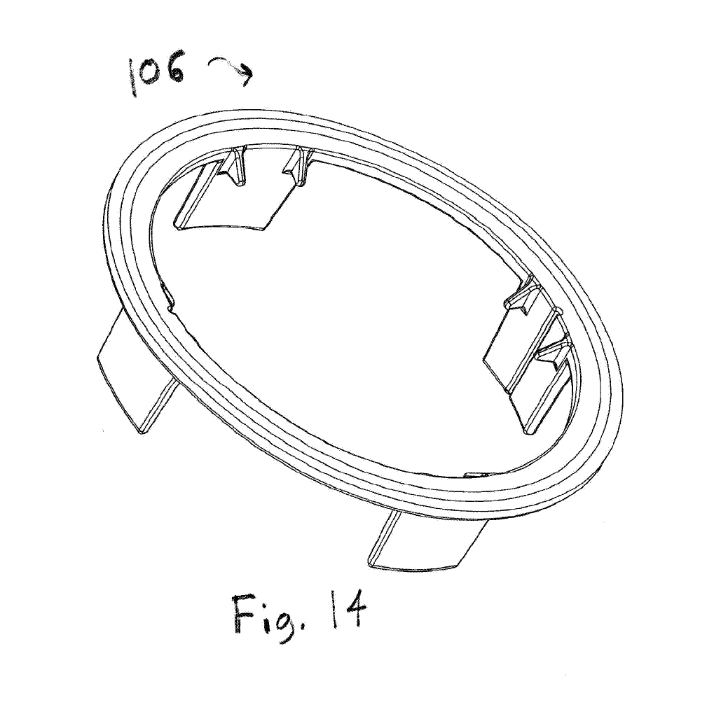

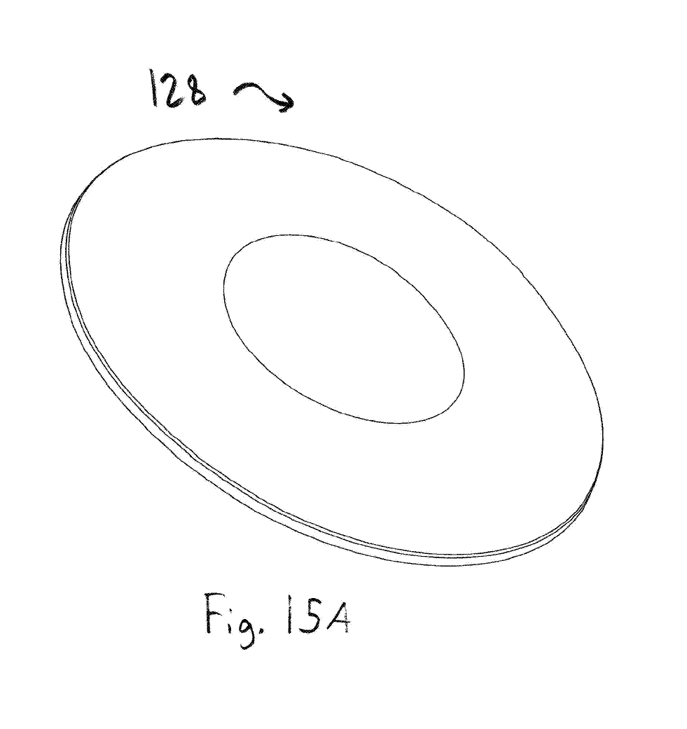

Speaker driver embodiments according to the present disclosure can comprise additional components, such as baskets or grilles. FIG. 14 displays basket 106, which can comprise a plastic material, such as black ABS plastic. In one embodiment, basket 106 can have a mass of 1.67 grams and a diameter of 52 mm. FIGS. 15A and 15B displays grille 128, which can comprise a steel material, such a 316 stainless. The grille can also be hexagonally perforated with a 79% open area, including a 0.5 mm thickness. The grille can also comprise a black electroless nickel plate including 7% phosphorus. In one embodiment, grille can have a diameter of 47 mm and a mass of 1.7 grams. It is understood that baskets or grilles according to the present disclosure can comprise any number of appropriate dimensions or materials.

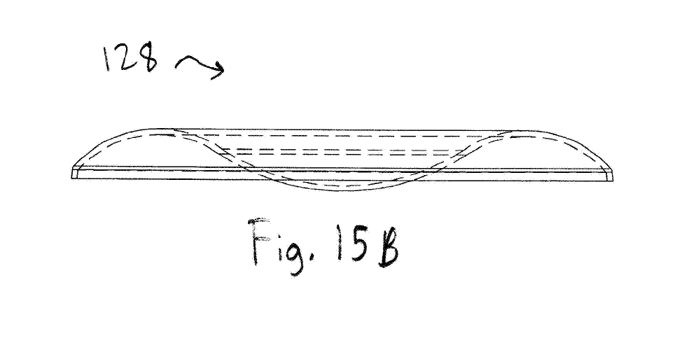

Speaker drivers according to the present disclosure can also comprise other magnet configurations. FIG. 16 is a bottom side perspective one such embodiment, speaker driver 200, which utilizes a dual magnet layout. In this embodiment, the dual magnets are adjacent each other and at approximately the same height in the speaker driver.

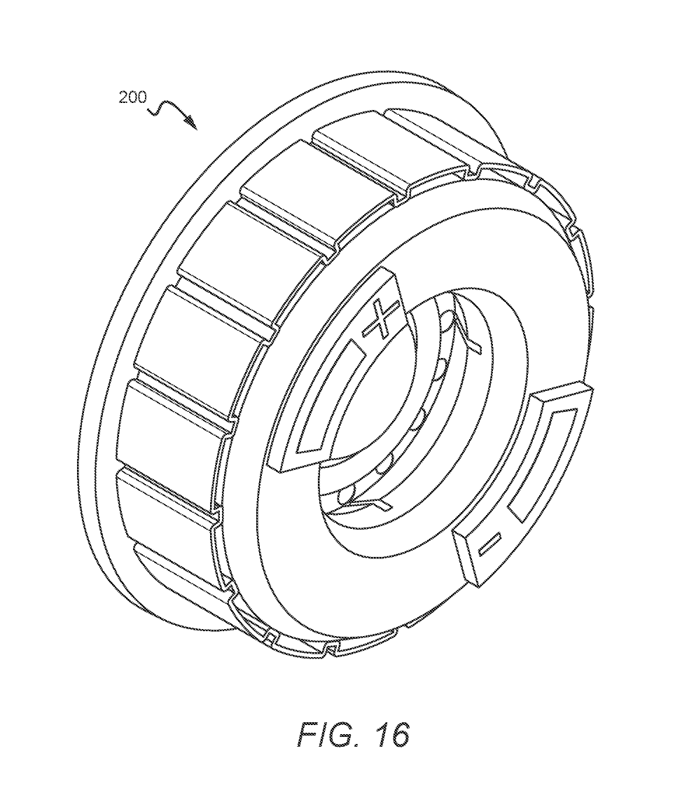

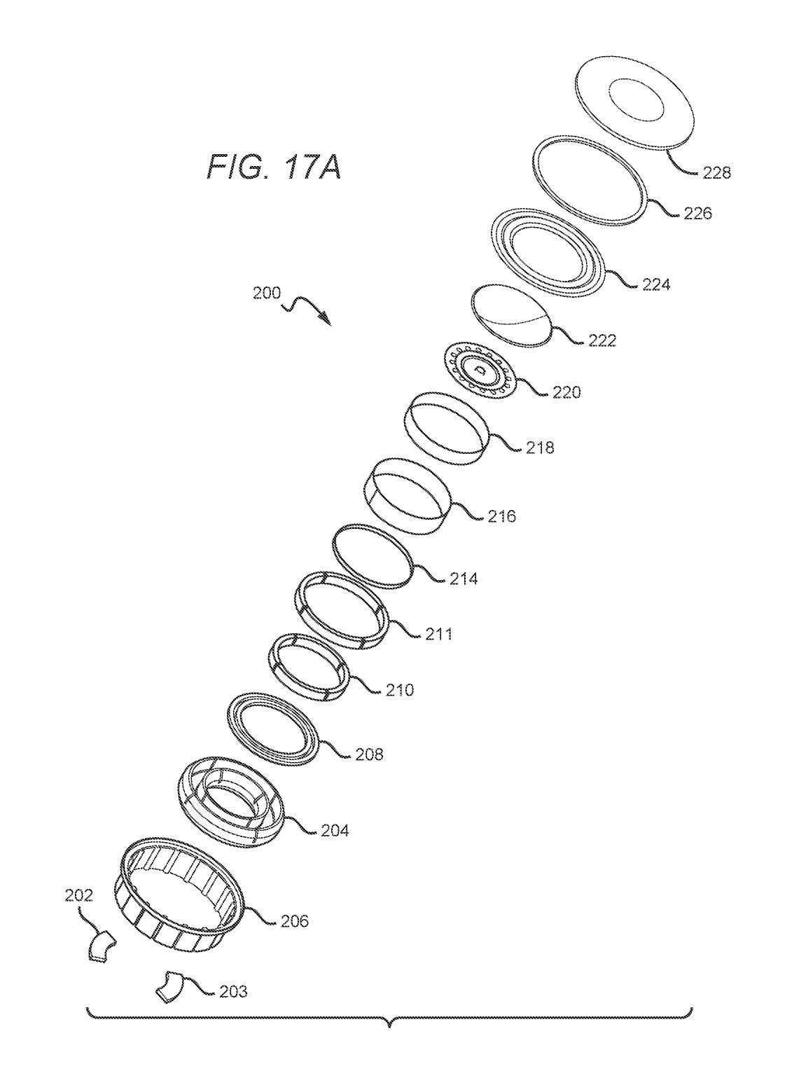

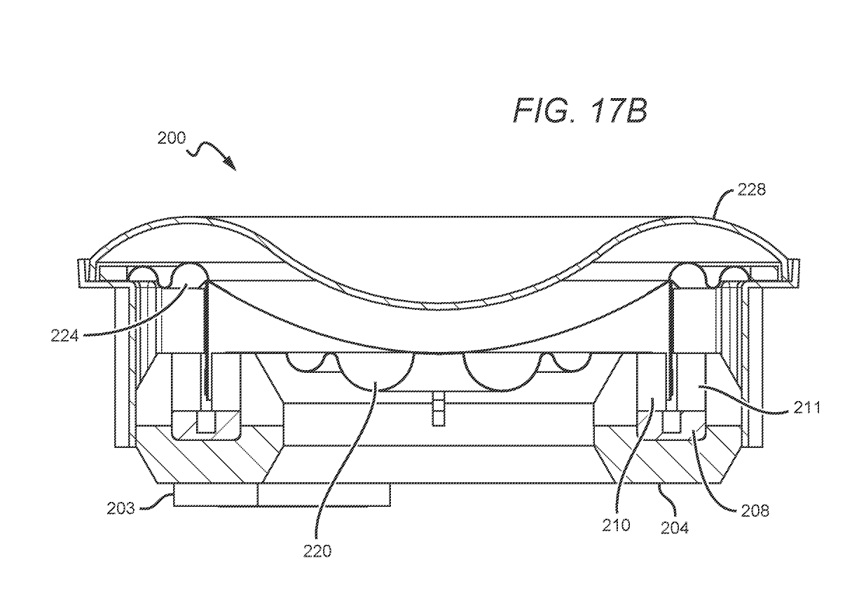

In order to properly display the components present in this embodiment, FIG. 17A provides an exploded view of speaker driver 200. As shown in FIG. 17A, speaker driver 200 comprises base cup 204, Faraday ring 208, inside magnet 210, and outside magnet 211. As discussed above, these components make up the motor assembly portion of the driver. Basket 206 and terminal board 202/203 are adjacent the motor assembly components. Speaker driver 200 also comprises voice coil 214, bobbin 216, and collar 218, which comprise the voice coil assembly portion of the driver. Furthermore, speaker driver 200 comprises rear suspension 220, inverted dome 222, front suspension 224, suspension ring 226, and grille 228. FIG. 17B provides a view of the respective component positions of speaker driver 200.

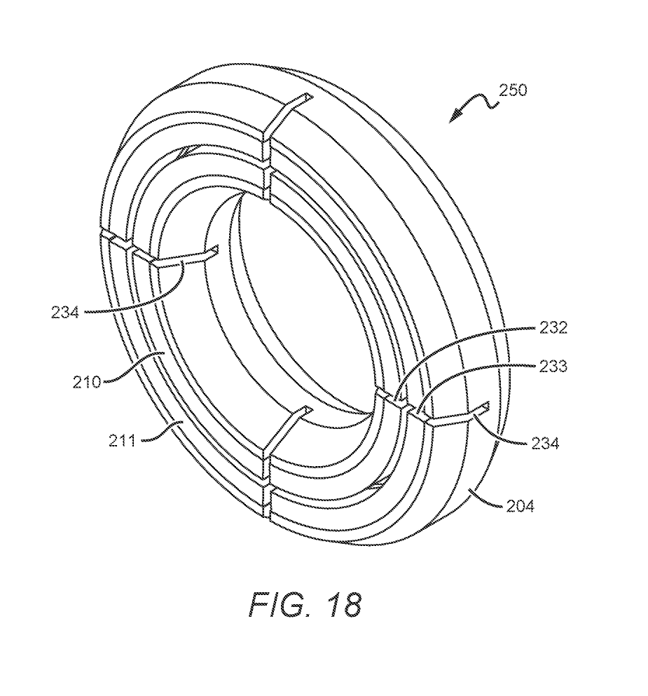

Dual magnet embodiments of the present disclosure can also comprise the novel and improved alignment features described herein. FIG. 18 displays motor assembly 250, which comprises base cup 204, base cup slots 234, Faraday ring 208 (not shown in FIG. 18), inside magnet 210, inside magnet gaps 232, outside magnet 211, and outside magnet gaps 233. As displayed in FIG. 18, base cup 204 is aligned with inside magnet 210 and outside magnet 211. More specifically, base cup slots 234 are aligned with inside magnet gaps 232 and outside magnet gaps 233.

The dual magnet configuration of motor assembly 250 may produce different results compared to motor assemblies using single magnets. For example, single and double magnet embodiments can provide different levels of inductance reduction and/or sound output. One reason is that the magnet material has different electrical resistance than the base cup material, e.g. steel, so using two magnets can change the comparative resistance levels. Additionally, placing the magnet material around the voice coil has different inductance, as two magnet sides have a different inductance than one side. Further, the magnet material has a different permeability level than the base cup material. Using two magnets can also change the reduction of eddy currents and magnet strength modulation, as two magnet sides have lower modulation than one side. Moreover, the fringe flux outside the magnet gap can have a better symmetry when using two magnets, such that the distortion levels are reduced. Two magnets also provide more total magnet mass, which results in increased flux density and motor assembly strength. Accordingly, utilizing two magnets can provide several advantages compared to using a single magnet. However, single magnet embodiments also provide benefits over dual magnets, such as a reduced production cost.

Other novel and improved features may not be different when using a single magnet compared to a double magnet. For instance, air pressure reduction and/or air flow results should be similar when using a single magnet and a double magnet. Indeed, if the magnet gaps and base cup slots are the same corresponding widths, then use of a single magnet or a double magnet should not alter the expected results of air pressure reduction and/or air flow.

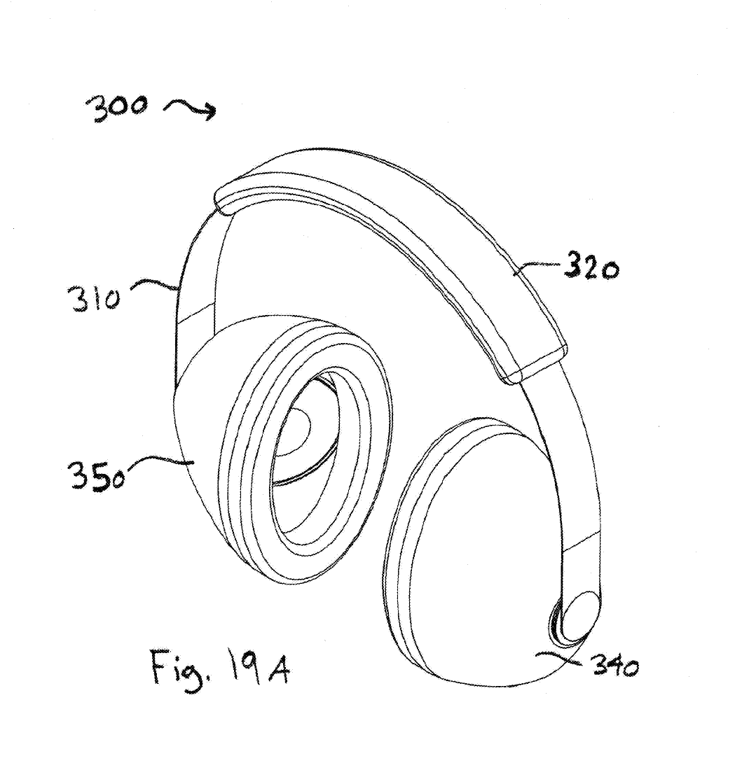

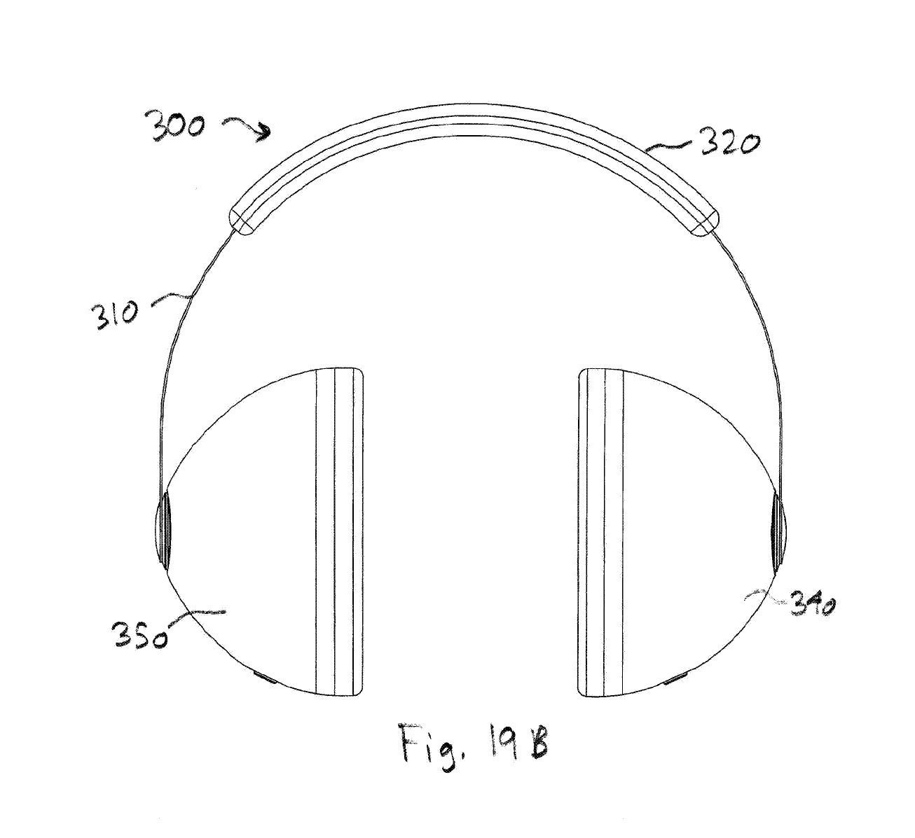

Speaker drivers according to the present disclosure can be part of larger devices, such as headphones. FIGS. 19A and 19B displays headphone assembly 300. Headphone assembly 300 comprises several different components, such as head band 310, head band pad 320, right cup assembly 340, and left cup assembly 350.

The relative position of each component headphone assembly 300 is also important. Therefore, FIG. 19C provides a view of the component positions of headphone assembly 300. FIG. 19C also identifies some of the individual components of left cup assembly 350, such as cup 358, speaker driver 370, diaphragm 372, ear pad 378, and connector 380.

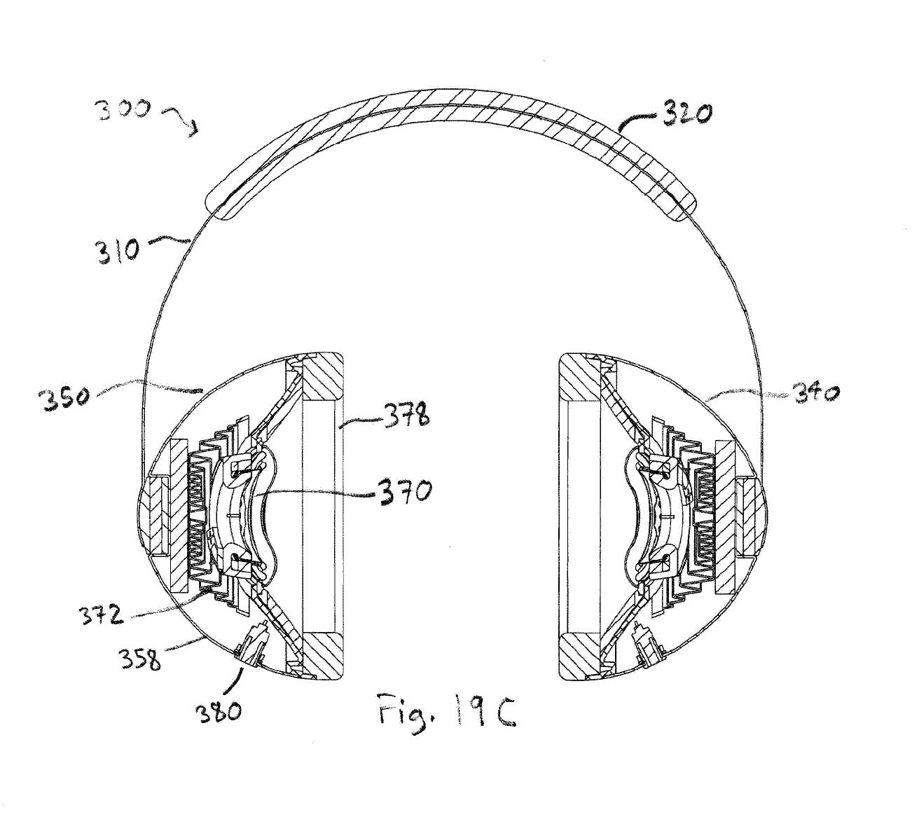

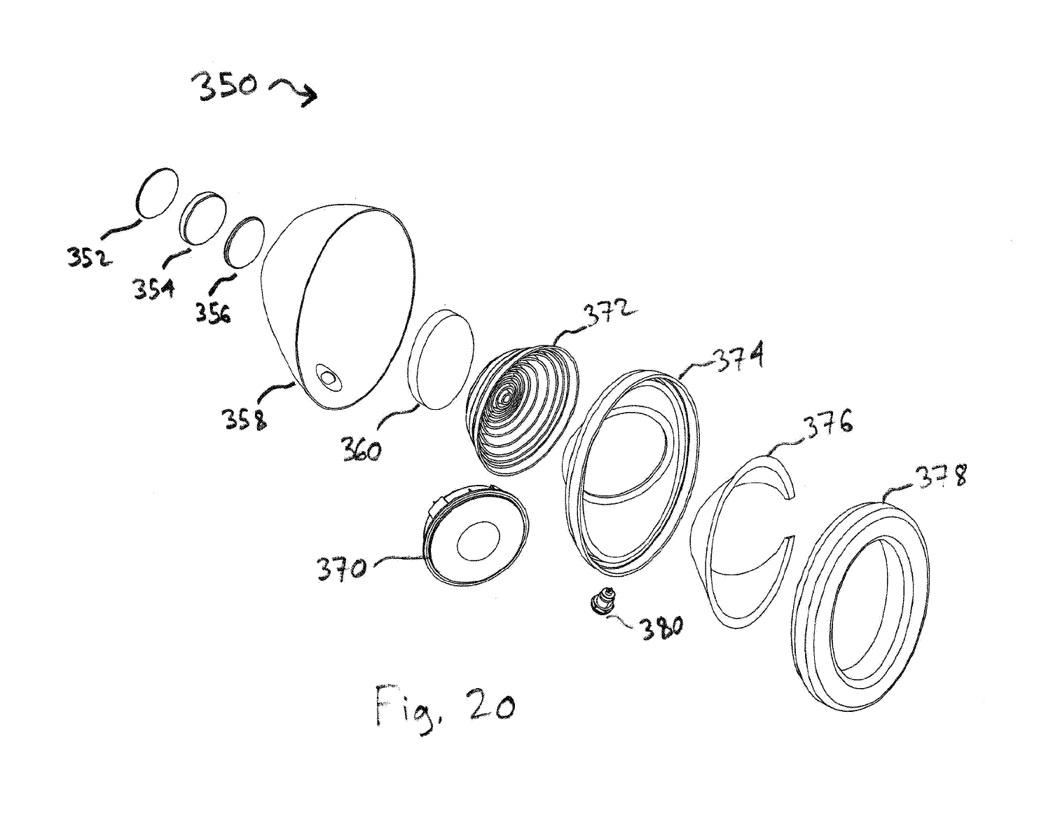

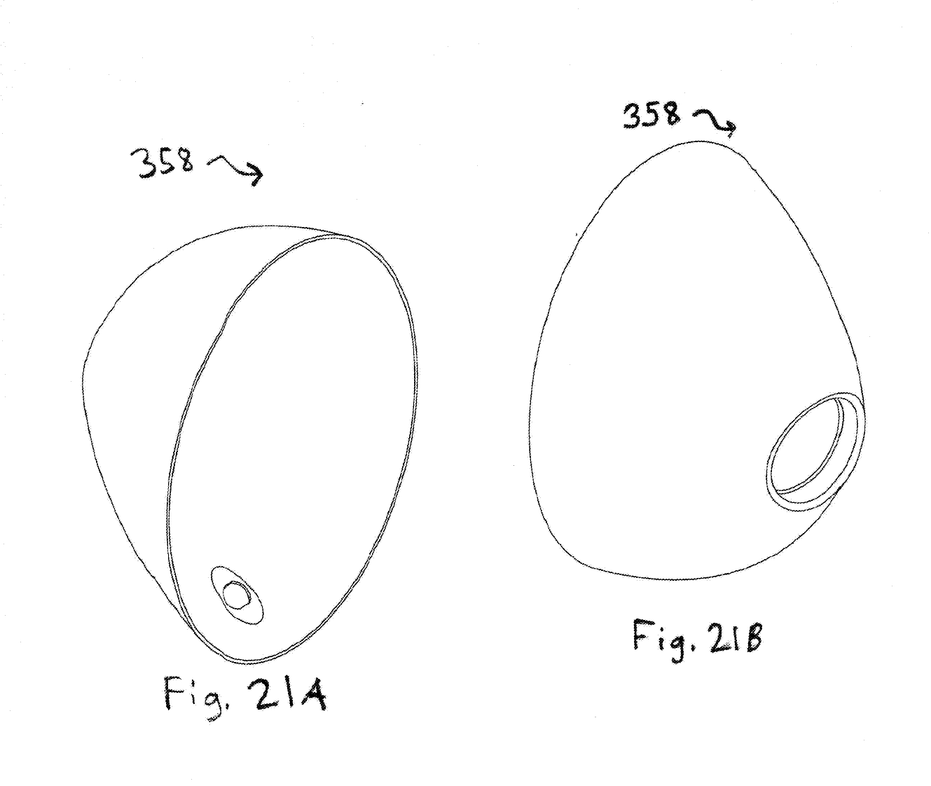

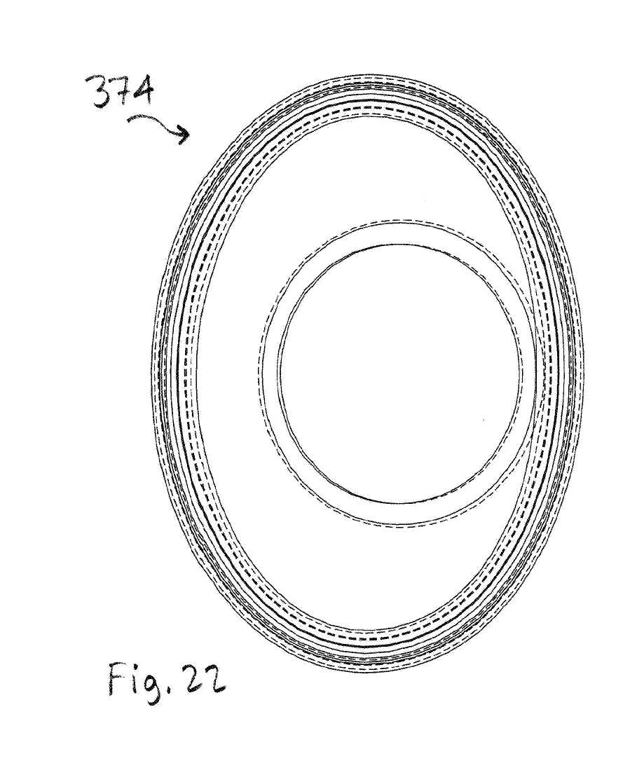

In order to properly display each of the components present in the cup assemblies, FIG. 20 provides an exploded view of left cup assembly 350. As shown in FIG. 20, left cup assembly 350 comprises tip bearing 352, tip magnet 354, tip pole 356, cup 358, tip cover 360, speaker driver 370, diaphragm 372, sound board 374, sound board cover 376, ear pad 378, and connector 380.

More detailed views of each component in left cup assembly 350 are provided herein. FIGS. 21A and 21B display cup 358, which can comprise a variety of appropriate materials, such a carbon fiber. More specifically, some cup embodiments of the present disclosure can comprise black twill carbon fiber with a high impact strength resin. In some embodiments, cup 358 can comprise a nominal wall thickness of 0.75 mm and a mass of approximately 20 grams. It is understood that cups according to the present disclosure can comprise any appropriate material, weight, or dimension.

The present disclosure also provides novel sound boards and similar components. FIG. 22 displays sound board 374. In some embodiments, sound board can comprise a natural color finish and a clear satin powder coat. Sound board 374 can also comprise magnesium and aluminum, wherein specific embodiments can have 23.7 grams and 37.4 grams of each material, respectively. In some embodiments, sound board 374 can comprise a nominal wall thickness of 1.5 mm. FIG. 23 displays sound board cover 376, which can comprise wool felt and a natural cream color. In some embodiments, sound board cover 376 can weigh 1.46 grams. It is understood that sound boards and sound board covers according to the present disclosure can comprise any appropriate material, weight, or dimension.

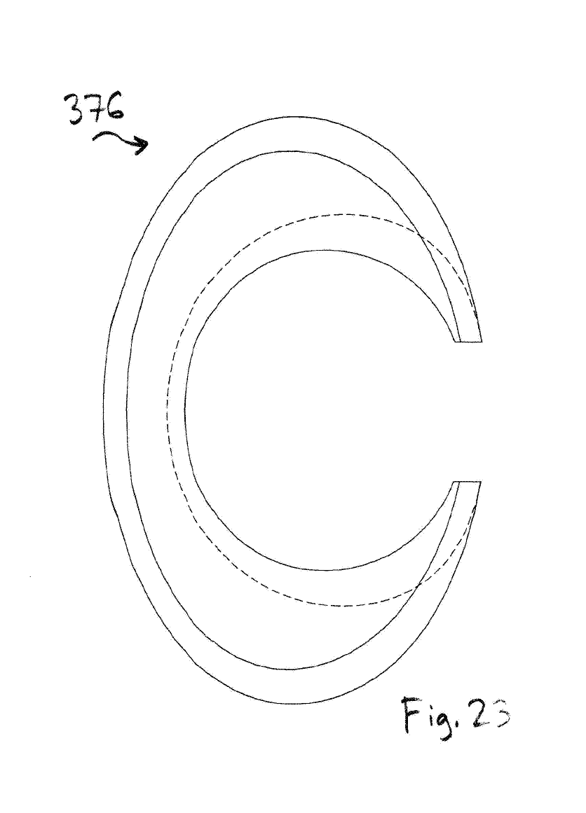

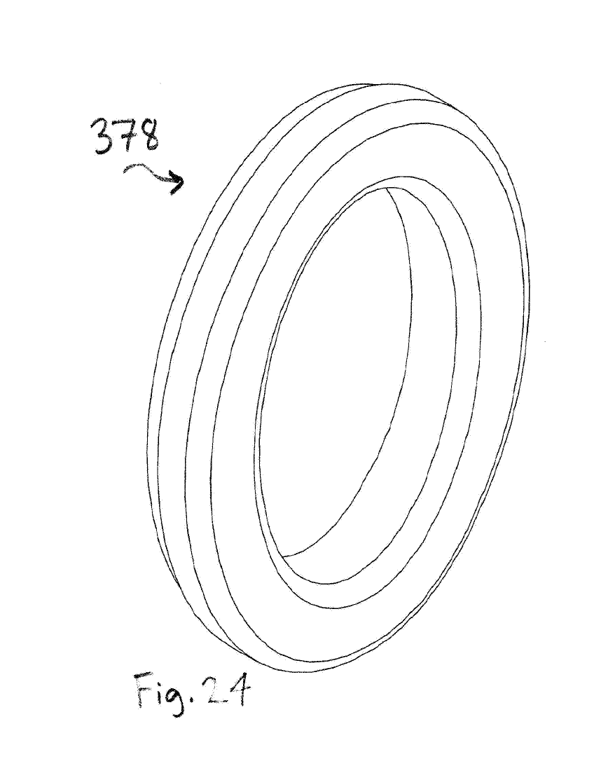

Cup assemblies according to the present disclosure can also comprise additional cover components. FIG. 24 displays ear pad 378, which can comprise memory foam, such as a high resilient memory foam and/or a soft, low density foam with characteristics of around three pounds per cubic feet. Some embodiments of ear pads can also comprise black sheep glove leather covers. In some embodiments, ear pads according to the present disclosure can weigh around 1 gram. FIG. 25 displays tip cover 360, which can comprise wool felt and a natural cream color. In some embodiments, tip cover 360 can weigh 1.54 grams. It is understood that ear pads and tip covers according to the present disclosure can comprise any appropriate material, weight, or dimension.

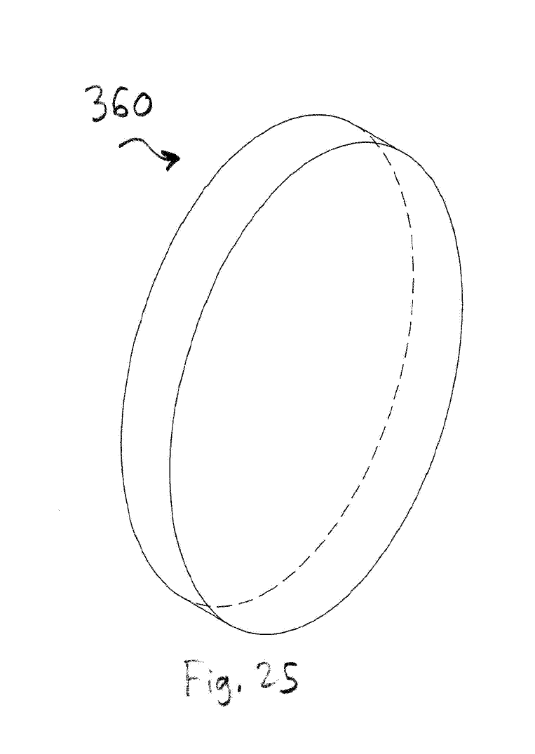

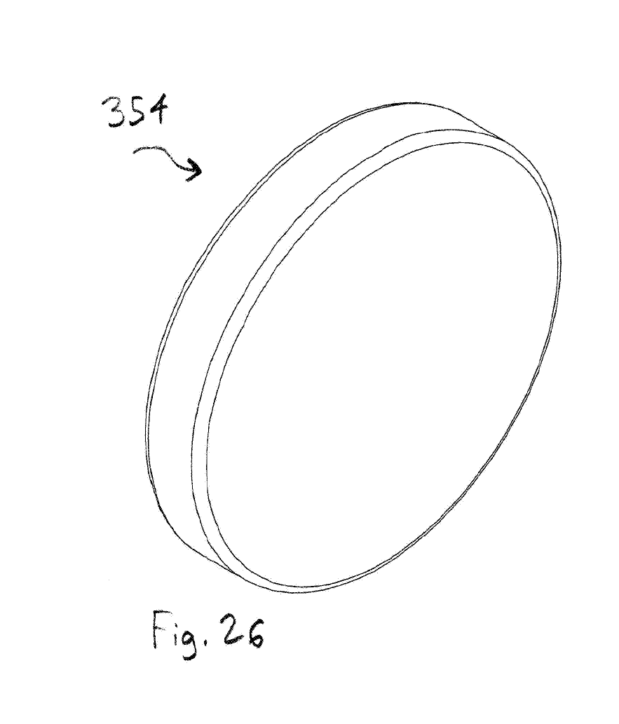

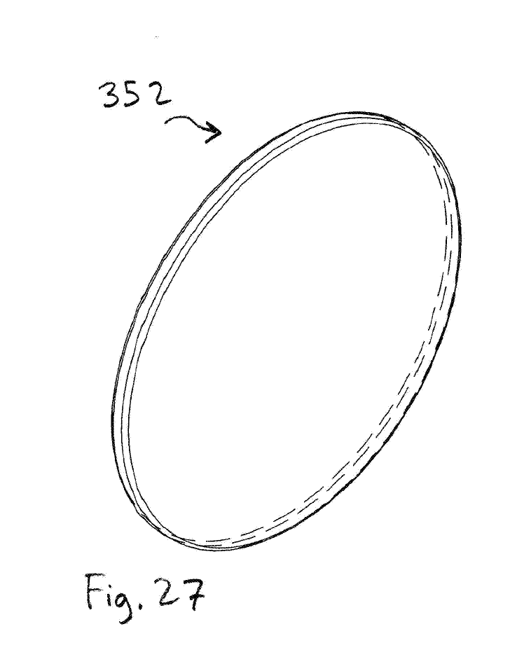

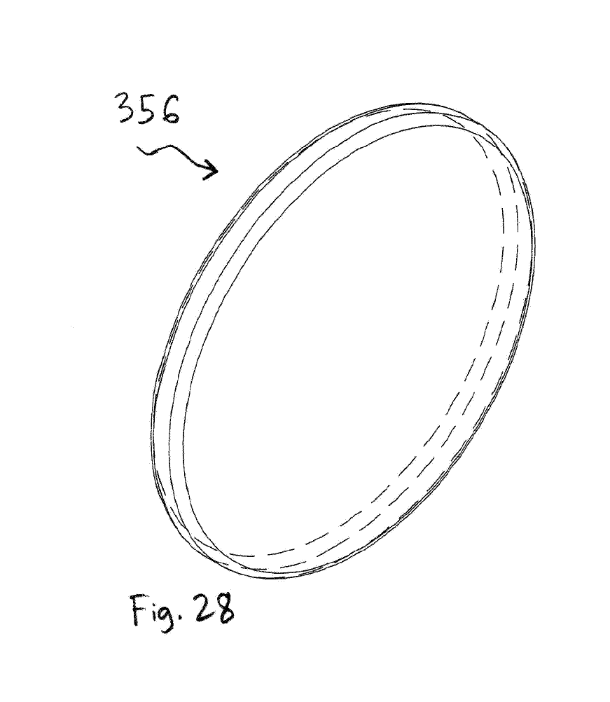

The tip of the left cup assembly comprises several components, such as a magnet, bearing, and pole. FIG. 26 displays tip magnet 354, which can comprise a nickel material with a black coat, as well as be magnetized with license. In some embodiments, tip magnet 354 can weigh 14.3 grams. FIG. 27 displays tip bearing 352. Tip bearing 352 can comprise a type of steel material, such as 409 stainless steel, and have a satin finish. In some embodiments, tip bearing 352 can weigh 8.7 grams. FIG. 28 displays tip pole 356, which can also comprise a steel material, such as 409 stainless steel, and have a satin finish. In some embodiments, tip pole 356 can weigh 7.6 grams. It is understood that tip magnets, bearings, and poles according to the present disclosure can comprise any appropriate material, weight, or dimension.

Embodiments according to the present disclosure can also comprise components that have sound dampening capabilities. FIG. 29 displays diaphragm 372. Diaphragm 372 can comprise an accordion type shape to diffuse sound reflections, as well as provide a soft spring compliance. Furthermore, the shape of the diaphragm can be round so that it acts as a floating dipole membrane inside of an elliptical cup, so as not to cause a Helmholtz resonance. Diaphragm 372 can comprise a variety of appropriate materials, such as rubber, or more specifically high vibration loss rubber. As diaphragm 372 can have dampening capabilities, it can also be referred to as a dampening diaphragm. In some embodiments, the diaphragm can be 0.5 mm thick and have a diameter of around 66 mm. Moreover, the diaphragm can have a mass of approximately 152 grams. It is understood that diaphragms according to the present disclosure can comprise any appropriate material, weight, or dimension.

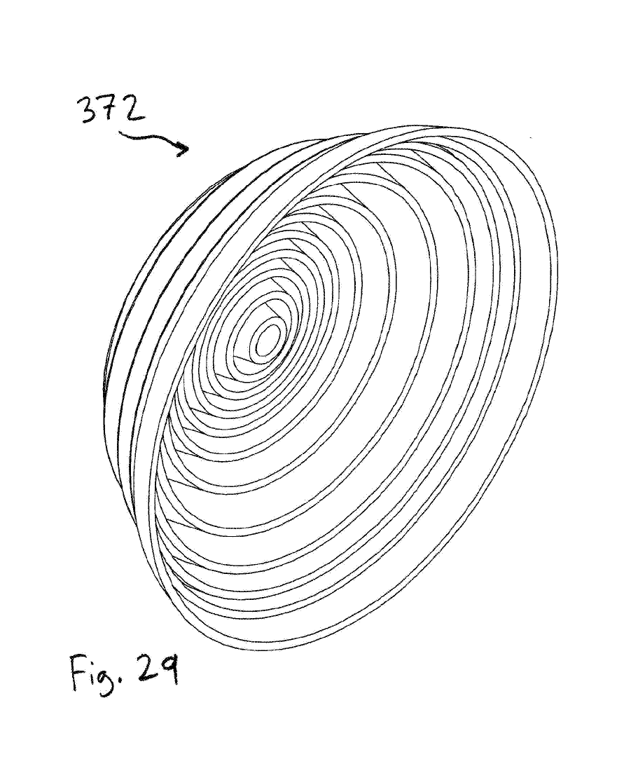

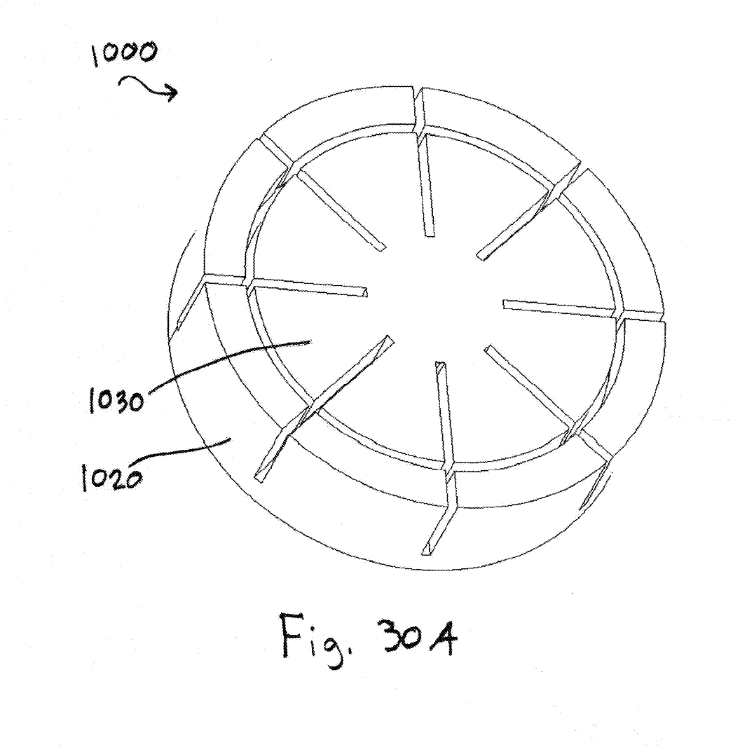

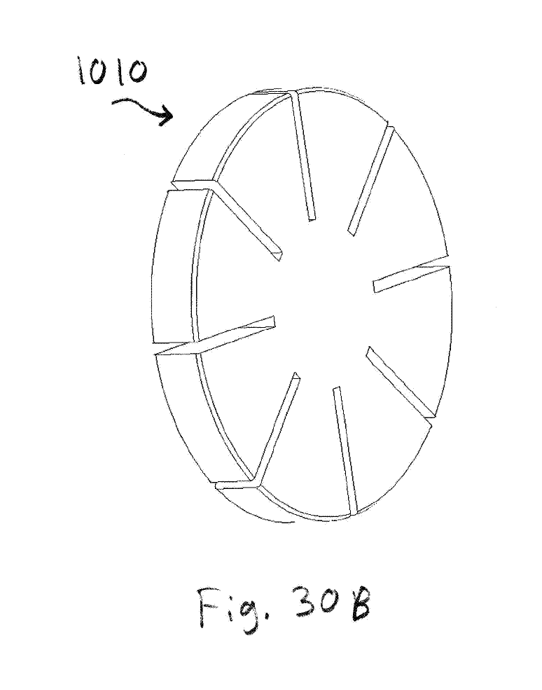

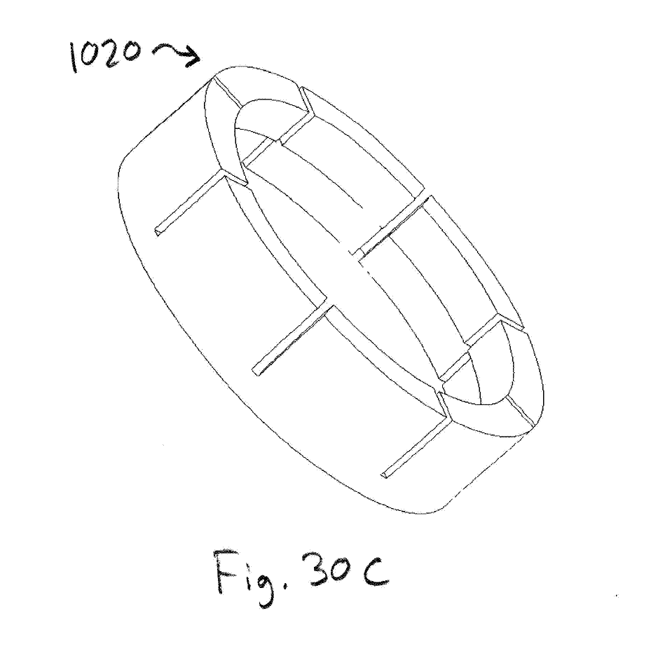

The present disclosure also provides embodiments with different speaker driver designs. Specifically, motor assemblies according to the present disclosure can have a wide variety of designs. FIGS. 30A-38 display motor assembly embodiments including a magnet inside a voice coil. FIG. 30A displays one such design of motor assembly 1000. Motor assembly 1000 can comprise magnet 1010 (not shown in FIG. 30A), base cup 1020, and top plate 1030, each of which are displayed in FIGS. 30B-30D, respectively. As shown in FIGS. 30A-30D, motor assembly 1000 comprises an eight slot design. Accordingly, magnet 1010 base cup 1020, and top plate 1030 each comprise eight slots. It is noted that the slots in magnet 1010 do not divide the magnet into segments. As such, magnet 1010 is a single piece, rather than a variety of individual segments.

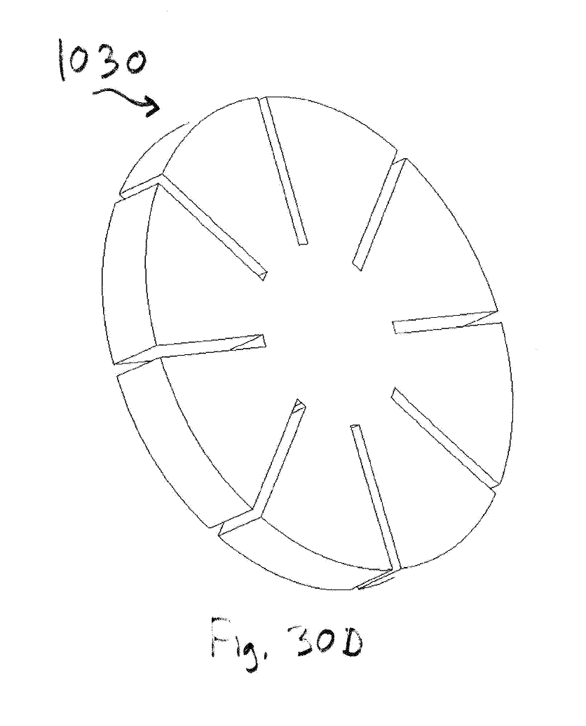

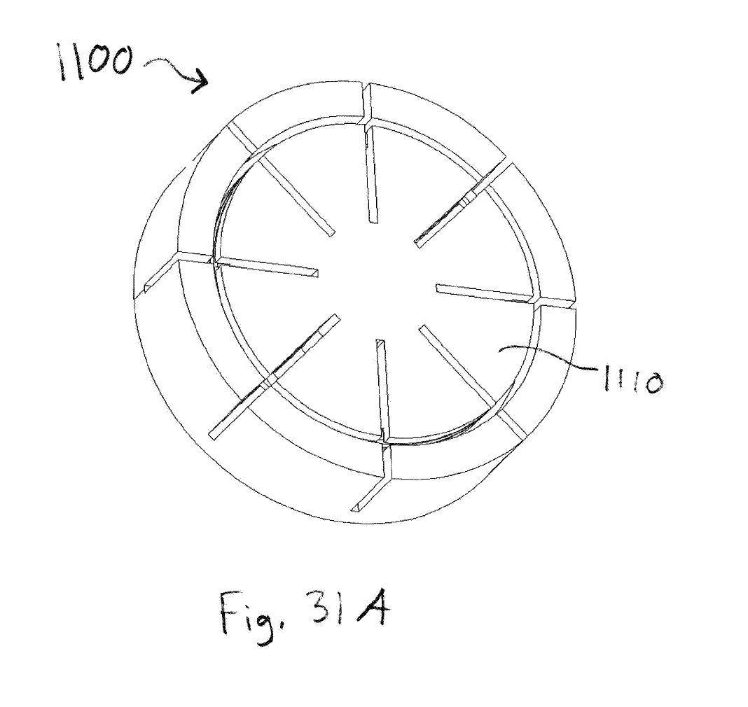

For the remaining motor assembly embodiments disclosed herein, only the distinctive components are shown. FIG. 31A displays motor assembly 1100, which comprises top plate 1110. Like the motor assembly above, motor assembly 1100 comprises an eight slot design. However, FIG. 31B displays that top plate 1110 has a distinctive dual outer edge design.

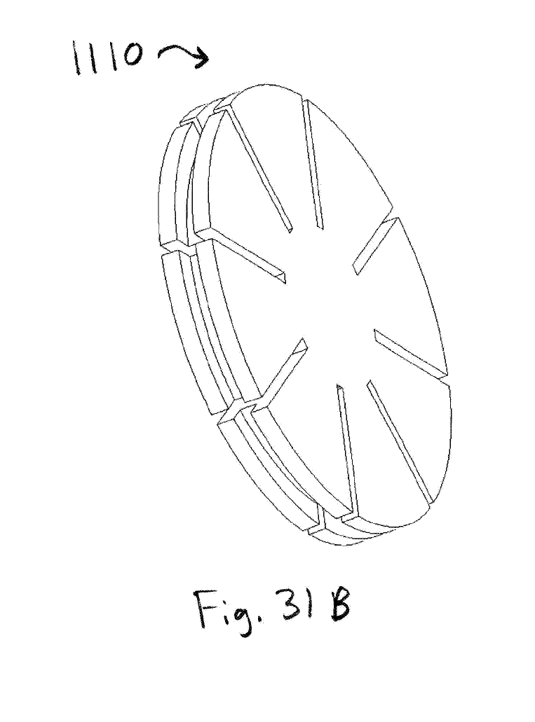

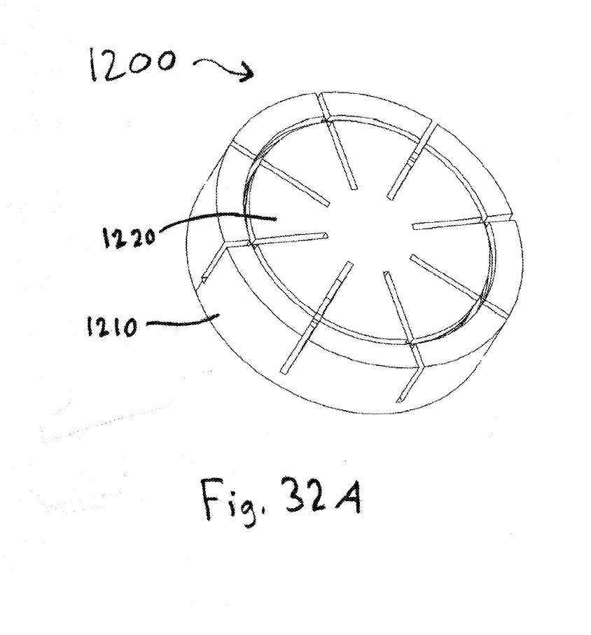

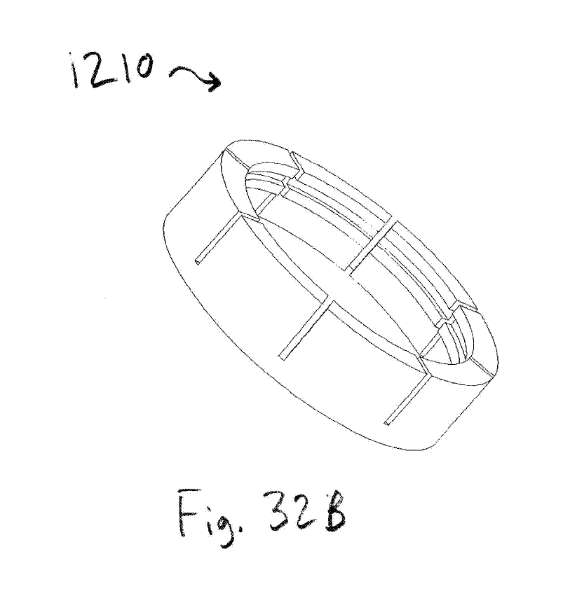

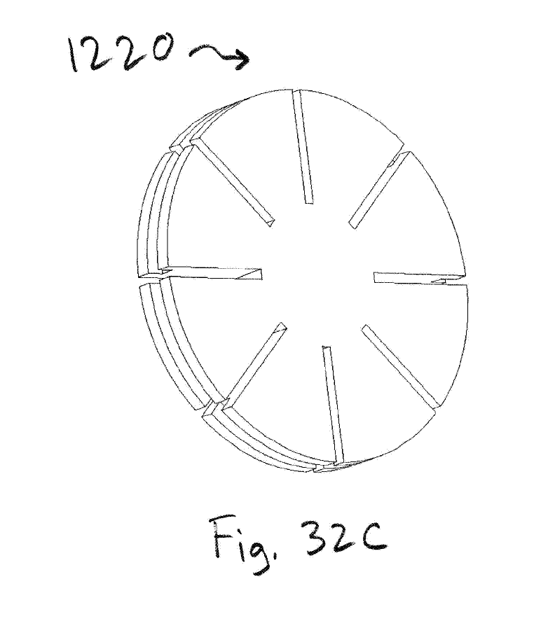

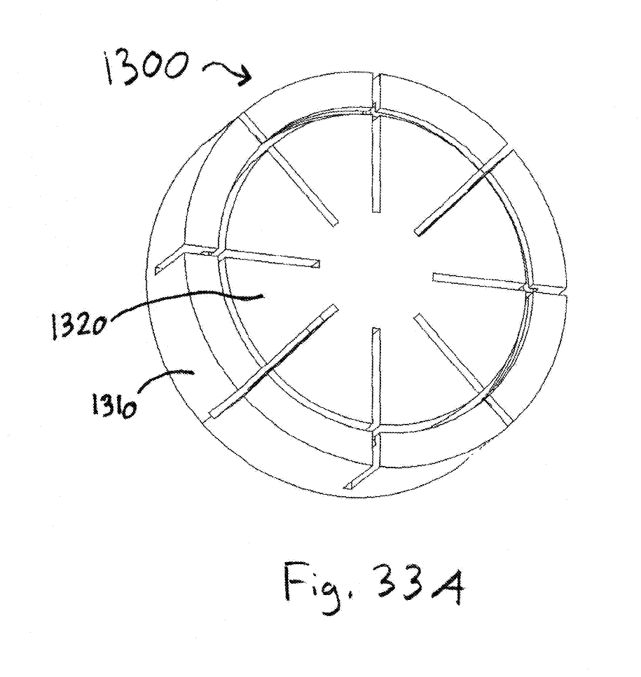

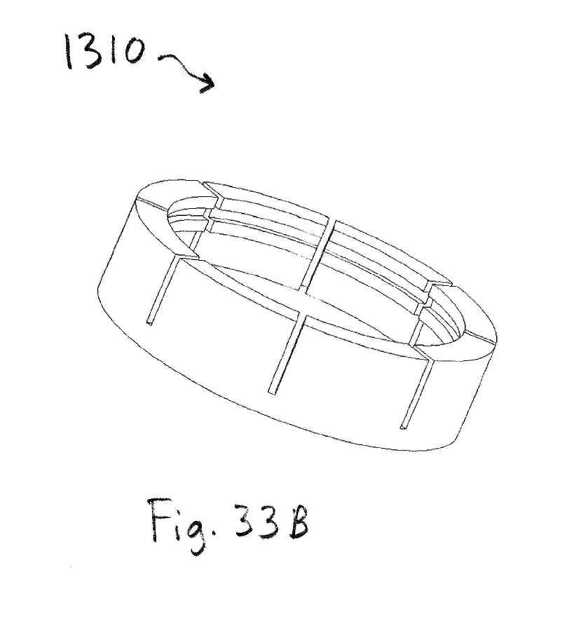

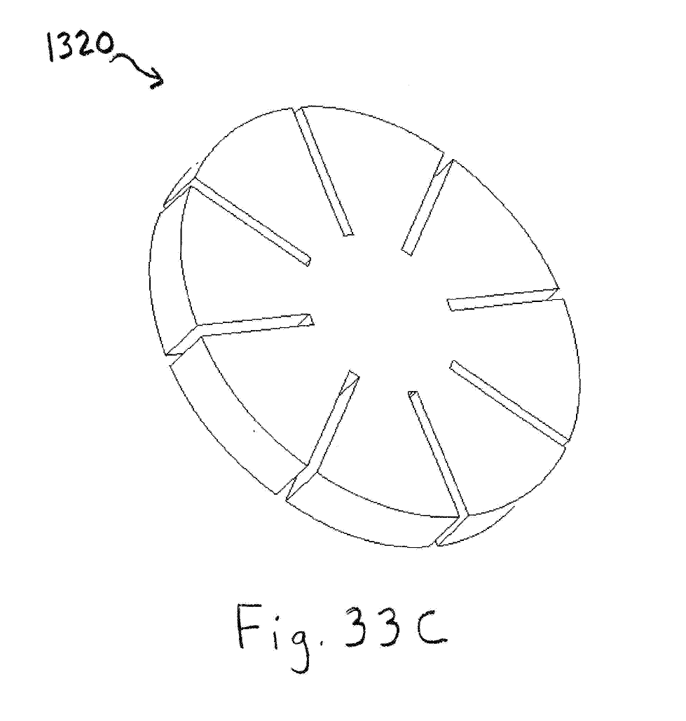

The motor assembly 1200 shown in FIGS. 32A-32C is similar to the motor assembly 1100 in FIGS. 31A-31B. Indeed, motor assembly 1200 utilizes an eight slot design, including a top plate 1220 with a dual outer edge design. Yet unlike motor assembly 1100, motor assembly 1200 comprises a base cup 1210 with a dual inner edge design to correspond to the top plate 1220 design. Additionally, FIGS. 33A-33C display motor assembly 1300 with an eight slot design, which is distinct from the two previous embodiments. Indeed, motor assembly 1300 comprises a base cup 1310 with a dual inner edge design, but top plate 1320 has a single outer edge.

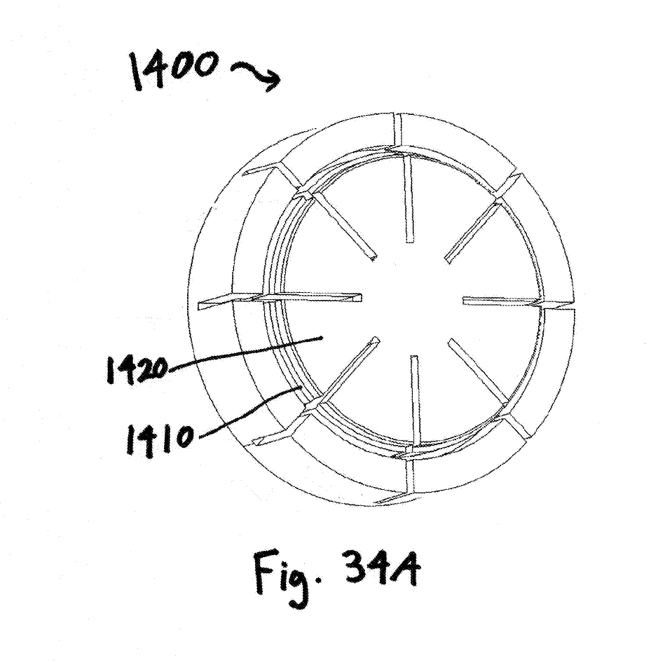

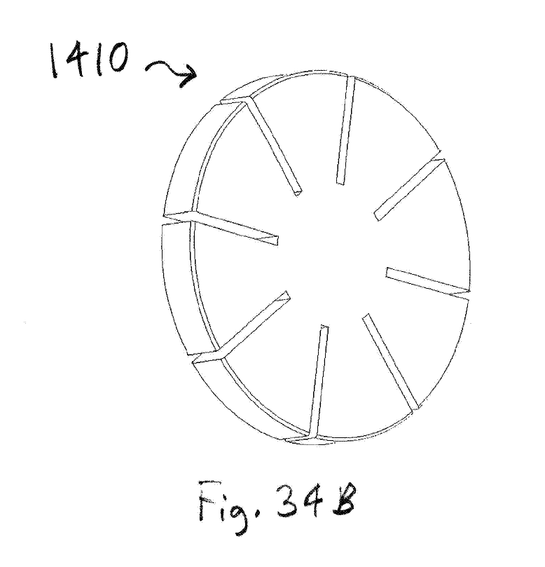

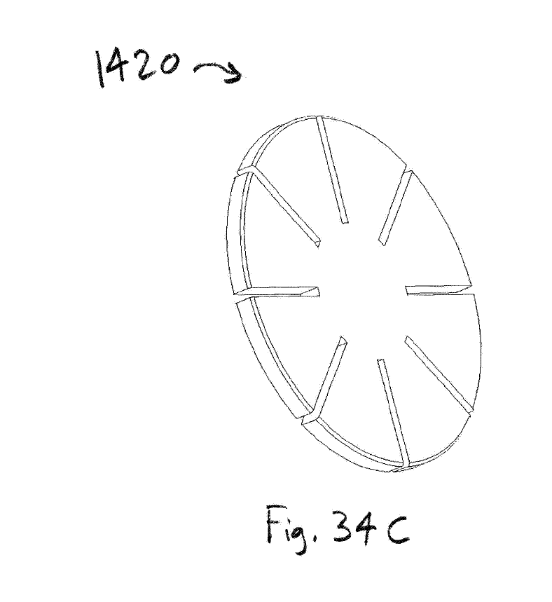

Motor assemblies according to the present disclosure can also comprise dual stacked magnet structures. FIG. 34A displays motor assembly 1400. Motor assembly 1400 comprises bottom magnet 1410 and top magnet 1420, as shown in FIGS. 34B and 34C, respectively.

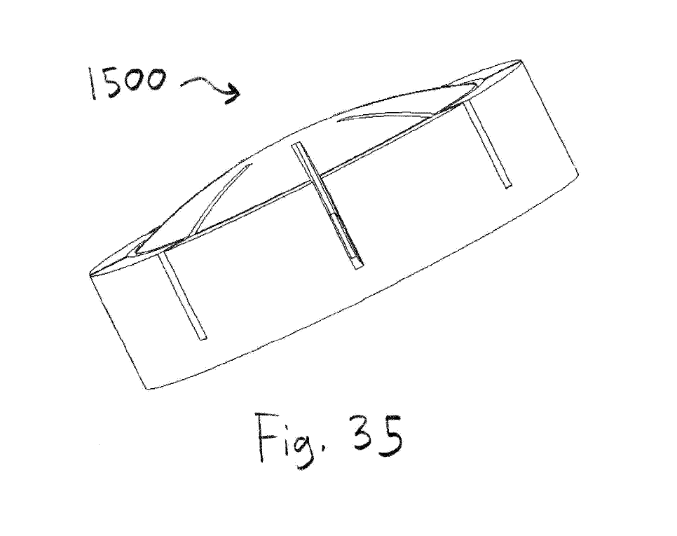

Motor assemblies according to the present disclosure can also comprise convex and concave dome structures. FIG. 35 displays motor assembly 1500, which comprises a convex or positive dome structure. FIG. 36 displays motor assembly 1600, which comprises a concave or negative dome structure.

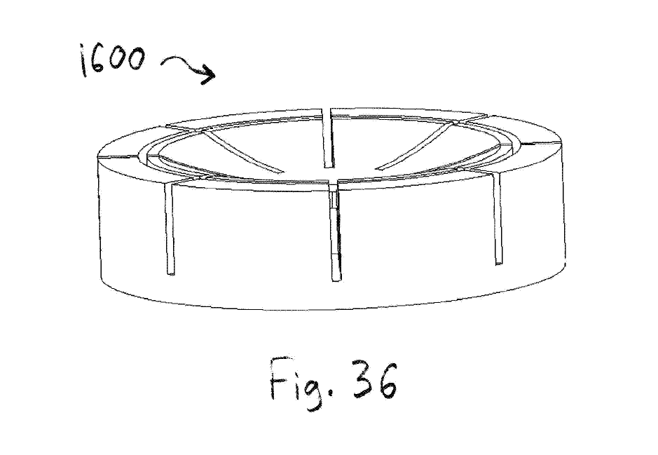

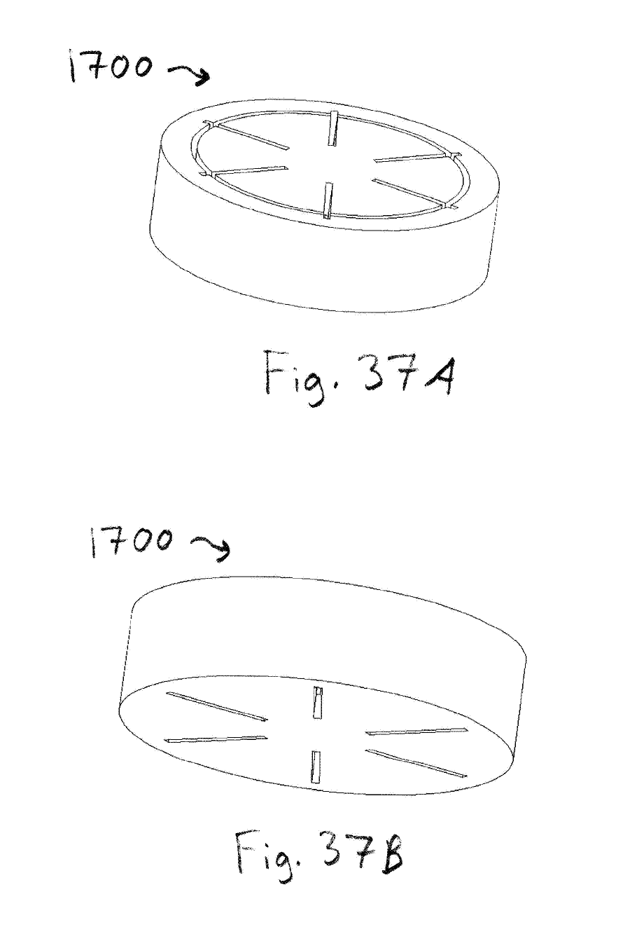

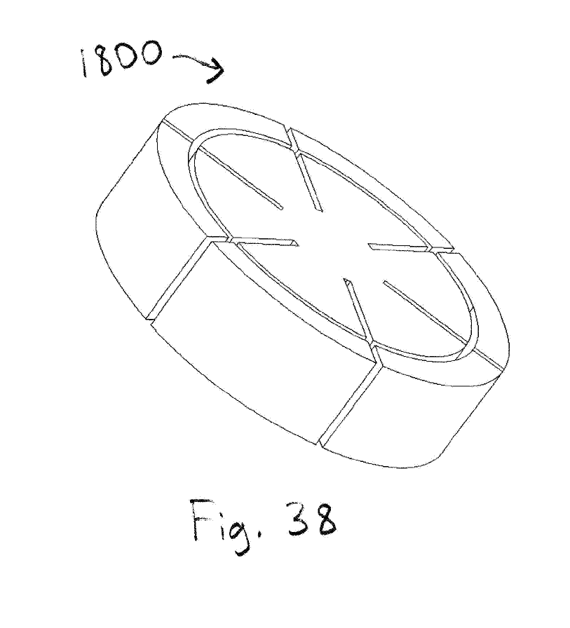

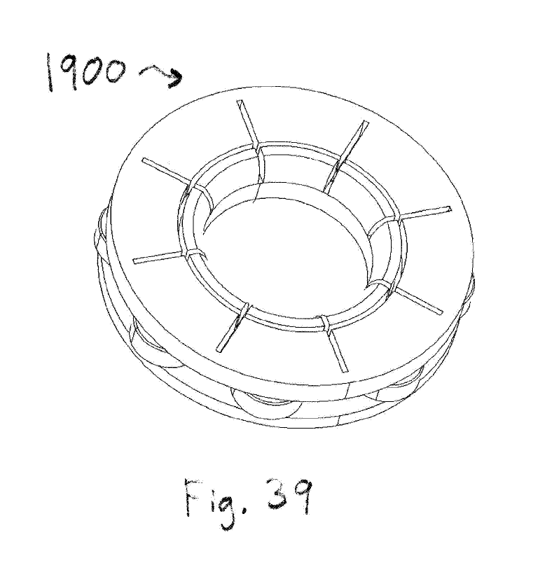

Embodiments according to the present can also comprise motor assemblies with different venting structures. FIGS. 37A and 37B display motor assembly 1700 which has a slot structure that vents through the device, wherein the slots are in the interior of the device and do not extend to the perimeter. FIG. 38 shows motor assembly 1800, wherein the slots extend to the perimeter of the device.

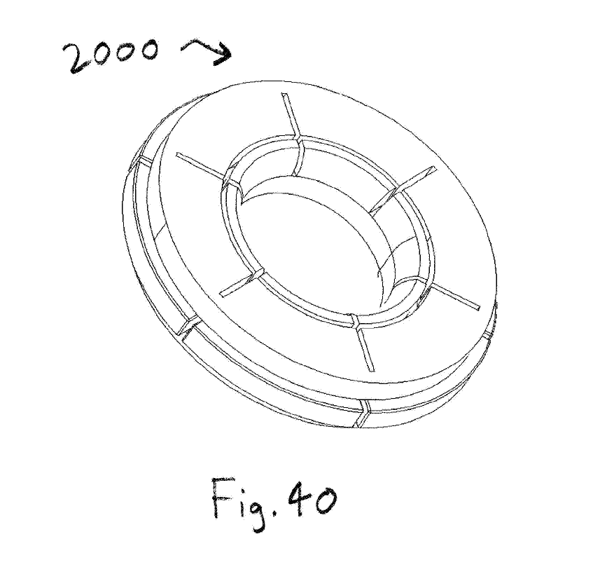

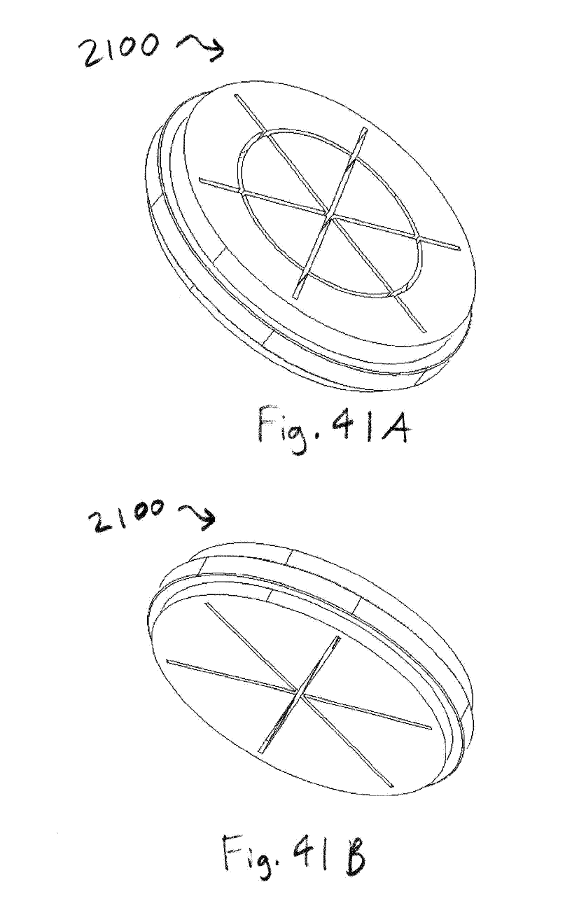

Other motor assembly embodiments include magnets outside of the voice coil, as shown in FIGS. 39-41 display. FIG. 39 displays motor assembly 1900, which utilizes an eight slot design and puck shaped magnets. FIG. 40 shows motor assembly 2000, which uses a six slot design and pie shaped magnets. FIGS. 41A and 41B display motor assembly 2100 comprising a six slot design and a ring magnet.

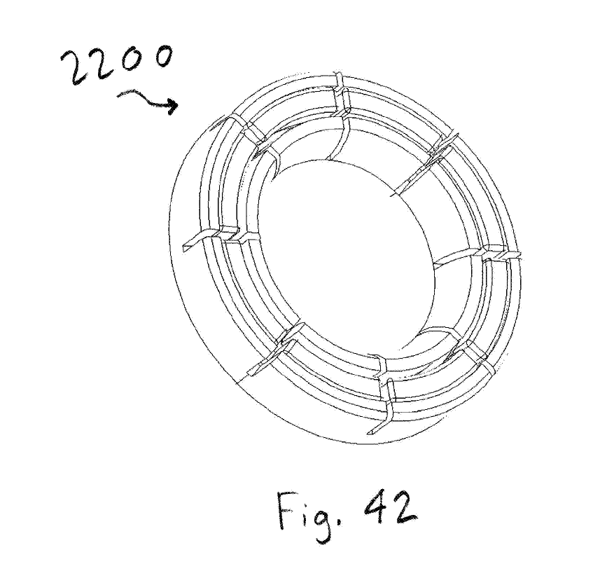

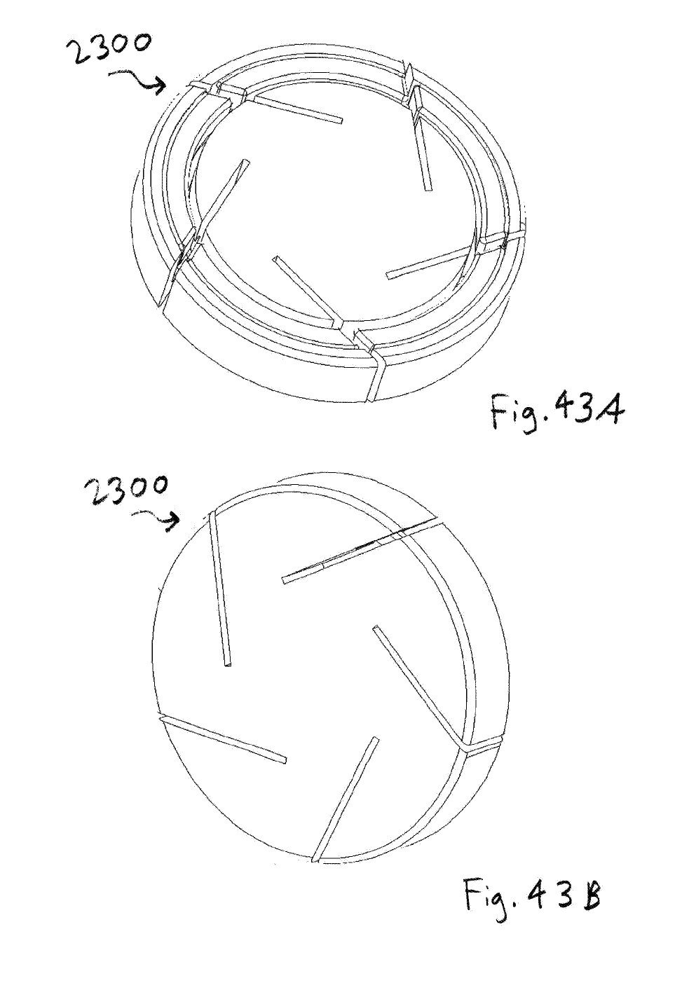

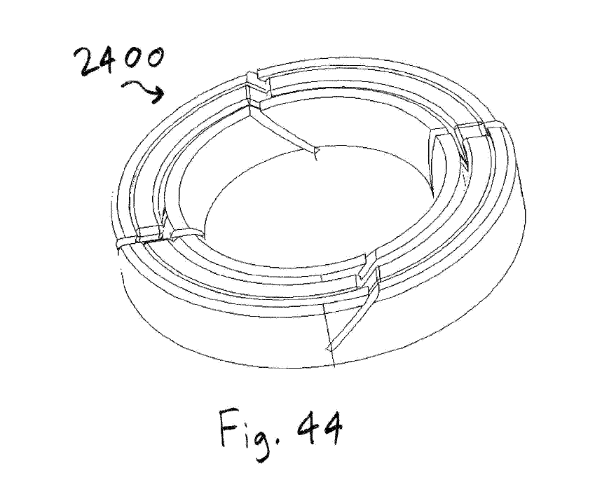

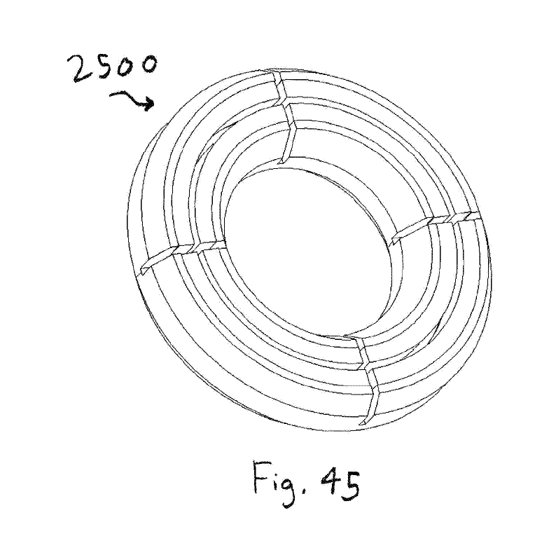

Yet other motor assembly embodiments according to the present disclosure include radial magnets, as shown in FIGS. 42-45. FIG. 42 displays motor assembly 2200, which comprises an eight slot design. FIGS. 43A and 43B show motor assembly 2300 utilizing a five slot design with angled slots. FIG. 44 displays motor assembly 2400 which uses a similar angled slot design, but with four slots. Finally, FIG. 45 displays motor assembly 2500 utilizing a four slot, dual radial magnet design.

It is understood that embodiments presented herein are meant to be exemplary. Embodiments of the present disclosure can comprise any combination of compatible features shown in the various figures, and these embodiments should not be limited to those expressly illustrated and discussed.

Although the present disclosure has been described in detail with reference to certain configurations thereof, other versions are possible. Therefore, the spirit and scope of the disclosure should not be limited to the versions described above.

The foregoing is intended to cover all modifications and alternative constructions falling within the spirit and scope of the disclosure as expressed in the appended claims, wherein no portion of the disclosure is intended, expressly or implicitly, to be dedicated to the public domain if not set forth in the claims.

1. A speaker driver, comprising:
a base cup comprising one or more slots and a raised outer rim; and
a magnet on said base cup, wherein said magnet comprises one or more gaps;
wherein said one or more slots are at least partially aligned with said one or more gaps.

2. The speaker driver of claim 1, wherein said one or more slots extend the same length as said one or more gaps.

3. The speaker driver of claim 1, wherein said one or more gaps extend entirely through said magnet, such that said magnet comprises one or more magnet segments.

4. The speaker driver of claim 2, wherein said one or more slots are the same width as said one or more gaps.

5. The speaker driver of claim 2, wherein said one or more slots are exactly aligned with said one or more gaps.

6. The speaker driver of claim 2, wherein said one or more slots comprise four slots; and
wherein said one or more gaps comprise four gaps.

7. The speaker driver of claim 1, further comprising a Faraday ring between said base cup and said magnet.

8. The speaker driver of claim 7, wherein said Faraday ring aligns the height of said one or more gaps with said one or more slots.

9. A speaker driver, comprising:
a base cup comprising one or more slots;
an inside magnet on said base cup, wherein said inside magnet comprises one or more inside gaps; and
an outside magnet on said base cup adjacent said inside magnet, wherein said outside magnet comprises one or more outside gaps;
wherein said one or more slots are at least partially aligned with said one or more inside gaps and said one or more outside gaps.

10. The speaker driver of claim 9, wherein said one or more slots extend the same length as said one or more inside gaps and said one or more outside gaps.

11. The speaker driver of claim 9, wherein said one or more inside gaps extend entirely through said inside magnet, and wherein said one or more outside gaps extend entirely through said outside magnet, such that said inside magnet and said outside magnet comprise one or more magnet segments.

12. The speaker driver of claim 10, wherein said one or more slots are exactly aligned with said one or more inside gaps and said one or more outside gaps.

13. The speaker driver of claim 10, wherein said one or more slots are the same width as said one or more inside gaps and said one or more outside gaps.

14. The speaker driver of claim 10, wherein said one or more slots comprise four slots;
wherein said one or more inside gaps comprise four inside gaps; and
wherein said one or more outside gaps comprise four outside gaps.

15. The speaker driver of claim 9, further comprising a Faraday ring between said base cup and said inside and outside magnets.

16. The speaker driver of claim 15, wherein said Faraday ring aligns the height of said one or more inside gaps and said one or more outside gaps with said one or more slots.

17. A headphone assembly, comprising:
a left cup assembly and a right cup assembly, each cup assembly comprising:
a speaker driver, comprising:
a base cup comprising one or more slots and a raised outer rim; and
a magnet on said base cup, wherein said magnet comprises one or more gaps;
wherein said one or more slots are at least partially aligned with said one or more gaps.

18. The headphone assembly of claim 17, wherein said one or more slots extend the same length as said one or more gaps.

19. The headphone assembly of claim 17, wherein said one or more gaps extend entirely through said magnet, such that said magnet comprises one or more magnet segments.

20. The headphone assembly of claim 17, further comprising a Faraday ring between said base cup and said magnet.
